(19) United States
(12) Patent Application Publication
(10) Pub. No.: US 2022/0417313 A1
(43) Pub. Date: Dec. 29, 2022

(54) DIGITAL MEDIA DATA MANAGEMENT SYSTEM COMPRISING SOFTWARE-DEFINED DATA STORAGE AND AN ADAPTIVE BITRATE MEDIA STREAMING PROTOCOL

(71) Applicant: Zorachka, Inc., Ladera Ranch, CA (US)

(72) Inventors: Ruslan Vinahradau, Minsk (BY); Vladimir Perekladov, Minsk (BY); Uladislau Bialiauski, Minsk (BY); Aliaksei Brek, Minsk (BY)

(21) Appl. No.: 17/144,098

(22) Filed: Jan. 7, 2021

Related U.S. Application Data
(60) Provisional application No. 62/959,094, filed on Jan. 9, 2020.

(51) Int. Cl. H04L 65/80; H04L 65/1045; H04L 65/65; H04L 9/00; H04L 9/32

(52) U.S. Cl. CPC H04L 65/80; H04L 65/1045; H04L 65/65; H04L 9/006; H04L 9/3273; G06F 21/64

(57) ABSTRACT

A digital media data management system in the field of software solutions deployed to an apparatus satisfying the specific hardware requirements. The system's purpose is to register, process, store and transfer data (mostly media). More specifically, the system comprises custom embedded firmware—the media server encapsulating the complete cycle of registration, processing (pre- and post-), storing in a permanent memory and transferring of data over networks, using for these purposes the proprietary implementations of the software-defined data storage service and the custom data streaming technique. Later

### CROSS-REFERENCE TO RELATED APPLICATIONS

This non-provisional patent application claims priority to U.S. Provisional Patent Application 62/959,094 “Integrated Advanced Multi-User Smart Home Video Surveillance System” Vladimir Perekladov, Ruslan Vinahradau, Uladislau Bialiauski, Siarhei Haiduchonak, Aliaksandr Karnavushenka, Alexey Trufanov, Aliaksandr Ivanou, and Aliaksandr Harbachou, filed Jan. 9, 2020.

This non-provisional patent application is further related to the following US patent applications:
1. U.S. Non-Provisional patent application Ser. No. 17/142,303, “Spherical Camera With Magnetic Base”, filed on Jan. 6, 2021.
2. US Design Patent Application 29/765,222, “Electronic Device—Security Camera” filed on Jan. 6, 2021.
3. U.S. Non-Provisional patent application Ser. No. 17/143,365, “Single-screen timeline-based interactive graphical user interface design concept and the set of user experience rules for consuming multimedia data on a handheld device touchscreen”, filed on Jan. 7, 2021;
   each of which is hereby incorporated herein by reference.

### FEDERAL RESEARCH STATEMENT

None

### FIELD OF THE INVENTION

The disclosed digital media data management system refers to the field of software solutions deployed to an apparatus satisfying the specific hardware requirements. The system's purpose is to register, process, store and transfer data (mostly media). More specifically, the system comprises custom embedded firmware—the media server encapsulating the complete cycle of registration, processing (pre- and post-), storing in a permanent memory and transferring of data over networks, using for these purposes the proprietary implementations of the software-defined data storage service and the custom data streaming technique. The further consideration of implementation embodiment hereinafter discloses the Homam camera data management system together with its internal components VIS (the service to record and store data) and HOVSP (the data transfer protocol). However, the disclosed embodiment is merely exemplary and may be customized by the person skilled in the art. For ease in understanding the disclosed invention, the commercial names Homam, VIS, and HOVSP are used throughout this specification.

As far as the invented and disclosed system is employed by the camera hardware, the main type of processed information within the considered ecosystem is media data (such as video and audio streams). Additional types of internal data are the different kinds of analytics and some other service metainformation. Also, further protocol customization is available for the purpose of using and processing data types that are different from the ones mentioned above.

The HOVSP streaming protocol specifies the universal common format of stored and transferred data within the entire Homam system infrastructure; each of the media server components, encapsulated by the developed digital content management system, is acknowledged about the designated format and performs its own functions in preparation, storage or transfer of HOVSP data segments. Herein the incoming live stream of video and audio information (encoded with AVC, HEVC, AAC and/or applying other compression algorithms) is segmented by means of the Homam media server (the embedded firmware in the camera apparatus) in a strictly specified way according to the specified HOVSP container structure, after which the prepared data fragments are saved into the camera's internal memory unit and/or transferred over the network (depending on the client device request). The structural organization of HOVSP fragments, like the algorithms for data storing/transmitting with the aid of the invented protocol, is developed for the purpose of maximum optimization according to the needs of the Homam camera system and implies the covering of the technological aspects such as effective storing of segmented data with minimal possible fragmentation of saved information, providing straightforward access to random data parts by request of client device, transferring the prepared bitstream over the network with minimal possible overhead and leveraging caching mechanism, coupled with the data protection and traffic encryption mechanism integrated directly into the protocol.

VIS relates to software data-defined data storage systems. More specifically, the VIS system is a custom database implementation utilizing a loop recording mechanism, where any previously recorded data is preserved exactly within one full write/erase cycle, after which it is serially overwritten with new incoming data. The general types of stored and processed content for the preferred embodiment of the present invention are sequential audio and video fragments, together with some other time series data, but the system use is not limited only to those named structures. For the system to maintain reliable storage of information and effective random access to any specific content fragment, the input data stream needs to be properly structured and indexed.

The Homam media data management system is a complex of individual software functional components (both the above HOVSP and VIS and others) that has been developed aiming to solve the full range of problems about registration, processing, storing and transferring of data (mostly but not limited to media) from the direct source to the client while providing a decent level of security, efficiency and usability of content consumption for end users.

### BACKGROUND OF THE INVENTION

Over the last several years, the “Internet of Things” has gained increasing prominence in everyday life. In particular, various smart home technologies are now widely used. In the scope of the present invention, an example of such an element of the smart home ecosystem is considered—the complex digital media data management system incorporated into a camera apparatus (mostly the software part of the implementation is specified herein—embedded media server firmware, but some set of specific architectural requirements is imposed upon the system without further limitation of generality).

To enable the inclusion of a specific camera into the smart home infrastructure, the device must offer a strictly defined range of hardware and software components and technical implementation characteristics. More specifically, the problems to be solved are: registration of video and audio information, processing of captured “raw” media streams on behalf of the camera system, organization of the instruments for effective recording, storing of and random access to the data and providing the way for data streaming, taking into account the existing network infrastructure. An important (and in most cases the primary) factor of the resulting implementation is the support for information encryption at all stages of the processing and transmitting process and the complex implementation of data protection.

The camera inherent in the above described embodiment serves as a protected multimedia server, executing the full range of tasks on data registration, processing, storing, retrieval and transfer. The camera serves simultaneously as an integrated data source, warehouse, processing unit and transmitter. As such, the camera must be both efficient on its own and advantageously combined with the whole smart home infrastructure. In this regard, many of the existing market samples have some significant limitations.

For instance, internal memory management is one of the significant limitations of many smart cameras currently on the market. In most cases these devices need to work in “dash cam mode”, i.e. save literally all the incoming data that is captured via optical sensors and microphones. Even employing the widely used video (AVC, HEVC) and audio (AAC) codecs for compressing the raw data streams, the resulting volumes of saved and rewritten information in per unit time are very significant, especially when it comes to flash memory hardware (in most cases the compact smart home cameras employ precisely that type of storage rather than e.g. HDD, for which the number of applied write/erase cycles is a less critical consideration).

Most widely used database management systems in combination with concrete file systems (as NTFS, FAT, EXT or HFS) are subject to different restrictions in writing, storing and reading the sequential data structures, e.g. video and audio fragments.

The first limitation is the high resource demands (the number of available processor cores and needed CPU clock rate, the amount of available RAM, etc.). Most popular DBMS widely used today are either optimized for relatively weak systems with very limited hardware capacities, or designed for execution on giant mainframes, with no capability limitations at all. Moreover, very rarely is a software storage system able to strike a balance between performance and resource consumption and adapt its execution to concrete hardware configurations or technical use cases by tweaking particular functional parameters' values.

Another drawback of conventional file systems is the repeated recording over the same memory areas, together with significant fragmentation during data deletion or migration. These problems decrease the data access rate (especially random access) and lead to significant incidental wear and tear of the end hardware unit (mostly due to flash memory having a limited number of write/erase cycles).

Another limitation of the operation of different file systems is the specific mechanism for controlling volume structure and providing fault tolerance—the use of the so-called superblock. This service block keeps system metadata about the full structure of stored data (e.g. total number of blocks, filled blocks, free blocks, root index node, etc.). This block is rewritten when any data change occurs, and if it becomes corrupted, recovery of information is not possible. Therefore, to protect the existing data structure, the superblock is duplicated in multiple places in the memory. As a result, the use of the superblock structure leads to a significant reduction of available write/erase cycles number and increases redundancy of stored data.

Additionally, many databases (especially relational ones) have a limit in the random access data rate (particularly when used in conjunction with a slow permanent memory hardware unit). Data indexing is a common way to improve the speed of the data retrieval operation, and different mechanisms can be used to implement the end indexing solution. For example, the self-balancing search tree is widely used as an indexing structure for a great number of database engines and file systems. However, for maximum efficiency, this tree needs to be located entirely in random-access memory. When there are great volumes of stored and processed information, this results in the additional consumption of RAM resources.

A great many camera manufacturers compromise on this issue by using an external memory card, pluggable into the internal slot of the device. In that case, when ROM wear and tear and failure occur, the memory unit can be ejected and replaced by a new one by the users themselves, without disassembly and potentially expensive repair. However, the described approach is obviously not optimal from the end user's point of view because it leads to overhead expenses and requires extra interference in the system's operation by the user.

Some producers do not even use the ROM in the camera at all. In this case, the media content is either not saved (user has access to the live stream only) or is transferred via the network to the cloud and kept there for a period of time. Obviously, the absence of a media archive is the significant drawback for the end user. Additionally, the storing of records in the cloud has a number of shortcomings, such as the inability for users to access their own data offline, extra network traffic costs between the camera and the cloud for saving and extracting content, and some additional risks related to securely transferring data to the cloud and keeping it there protected (in recent years there have been various instances of personal information loss from cloud storage).

In addition to storing data, the camera media server system needs to provide network transfer to the end user device. Nowadays there are several streaming protocols that can be more or less treated as the industrial standards. Each of them has its pros and cons, but none completely enables both effective live streaming and VoD (Video on Demand), which is critically important for the complex media data management system.

For instance, the so-called traditional streaming protocols like RTMP and RTSP demonstrate low latency (within 2-5 s) and don't require buffering, but are poorly scalable, not optimized enough for adaptive quality change “on the fly”, are highly demanding on network infrastructure, and work “out of the box” on a very limited number of client devices. Moreover, these protocols will most likely become obsolete to a significant degree in the not too distant future.

Another group of streaming protocols that are widely used in practice are the adaptive bitstream protocols based on HTTP. This group includes the popular technologies HLS and MPEG DASH. The advantages are their wide support of any client device, use of the existing network HTTP infrastructure for data transfer, embedded support for the most popular codecs and adaptivity of stream quality on the fly. However, without applying the resource-consuming calculations on the CDN's side for data preparation and distribution, the stream latency value is considerably large (˜6-30 seconds), which is absolutely unacceptable for live streaming.

Providing the overall protection of the camera media data management ecosystem and of the entire data transfer infrastructure is also one of the key aspects of the resulting device implementation. Ideally, every step of interaction with data within the implemented system (processing, storing, transferring) must be secured, and all incoming and outgoing traffic must be encrypted. That purpose is achieved by leveraging the standard approach of initial mutual authentication and authorization between all parties of data transmission (client, server, mediators if needed) with the use of the cloud, which performs administrative control of the process; and further applying all necessary cryptographic procedures while transferring data between already trusted counterparts, while still following the public key infrastructure (PKI) principles.

It is further important to mention and consider the performance and resource consumption of both individual components as well as the entire system as a whole, because the camera is naturally a compact device in most cases, with limited computing power CPU and a relatively small amount of available RAM.

To sum up, the essence of the invention disclosed in scope of the instant patent application is the developed architecture of the digital data management system, encapsulating software multimedia server that can be employed by camera's hardware with further device integration into smart home infrastructure. However the camera with installed media server software can act as the standalone unit too. The resulting software solution applied to specific hardware apparatus effectively performs the functions of registration, processing, storage and transmission of multimedia data, and is mostly free from the limitations mentioned above.

### SUMMARY OF THE INVENTION

The present invention is a complex digital media data management system, which is intended to be embodied in a protected software media server. In the case at hand the considered software media server encapsulates the components, methods and algorithms for the registration, processing, effective storage and network transfer of video, audio and auxiliary service data for the purpose of convenient content consumption via end user devices. Despite describing the software solution, the system-of-interest still relies on a hardware platform of certain architectural configuration. The considered ecosystem has been developed to provide a high level of fault tolerance, integrity and security for all data stored in the internal memory or transferred over networks. The invented solution should be treated not solely as the digital media server firmware alone, but also includes infrastructural components, employed to process and transfer content to the end user. The Homam® software platform (considered in detail hereinafter) is considered as the exemplary embodiment of the system. Homam® also encapsulates two other proprietary software components implementations for software-defined data storage service—Verona Index Storage (VIS™) and for adaptive bitrate streaming protocol (ABRSP)—Hyper Optimized Video Streaming Protocol (HOVSP™). All the named technologies (Homam®, HOVSP™) are the property of Zorachka Inc. and its affiliates, all rights reserved. However, it must be clearly understood, that the considered embodiment of the system described hereinafter in the form of the proprietary Homam® system is merely an exemplary implementation, and a person skilled in the art may use different methods, algorithms or change specific subcomponents to implement the same described functions for concrete technical application (still not departing from the scope of the original invention).

The key parts of the Homam ecosystem as a media server are the invented software components of HOVSP™ and VIS™.

The invented HOVSP™ technique according to its name represents the proprietary implementation of the protocol of the adaptive media content transfer via existing network infrastructure over application-level protocols like HTTP/HTTPS and/or WebSocket (the so-called over-the-top approach). Herewith for HOVSP™ to work properly there is no need for any additional dedicated server for data storage and distribution, content delivery network (CDN) except for the software media server Homam® itself, encapsulated in the camera's firmware. This fact distinguishes HOVSP™ from other implementations of similar technologies. HOVSP™ contains the embedded traffic encryption at a protocol level itself (that can be further complemented by SSL/TLS encryption) and also encapsulates the mechanisms for seamless adaptive data transfer under the different available network bandwidth conditions through the custom implementation of the self-descriptive advanced data segmentation technique. Additionally HOVSP™ demonstrates better streaming efficiency than that of industry peers due to HOVSP™ imposing low traffic overhead and employing caching techniques.

The developed VIS™ service is the effective proprietary software-defined storage service designed to reliably hold data for a limited period of time. The main functions of the system are correspondingly the writing of data to permanent memory and the reading of previously recorded data from the same non-transitory storage unit. The system constitutes the circular data storage by implementing a loop recording mechanism, that guarantees data durability within every single write/erase cycle and with complete absence of any fragmentation. The system performs at the highest possible efficiency while operating with sequential data structures such as video and audio fragments or massive log files. However, the present invention is not limited to this concrete usage only, as its proprietary component architecture allows for the customization or even replacement of particular components for adaptation to any arbitrary data type.

Furthermore, certain operating parameters of the invented system (e.g. RAM cache threshold or data block size) may be varied for use in a specific hardware environment.

The implementation of the preferred system embodiment is based on the alignment of the input content stream to the strictly defined data structure, which is well formed for further recording to a non-transitory storage hardware unit. In addition to the above, the invented software service is independent from the end storage system. The solution can be customized for use with virtually any apparatus and information storage concept (file system, block storage, object organization). The effective random access to any requested data fragment is managed by the custom data-indexing mechanism. Also, the invented system encapsulates software components controlling fault tolerance and data recovery in the event of hardware/software malfunction.

Each of the software components' concepts mentioned above, along with the complex data management system architecture as a whole, is considered and described in detail further in the text of the instant application by means of an example of the Homam® platform (complemented by HOVSP™ and VIS™ technologies).

### BRIEF DESCRIPTION OF THE DRAWINGS

Further aspects of the instant invention will be more readily appreciated upon review of the detailed description of the preferred embodiments included below when taken in conjunction with the accompanying drawings, of which:

FIG. 1 is a block scheme 10 of the architecture of the Homam digital media data management system as a whole.

FIG. 2 is a block scheme of the exemplary reverse proxy server infrastructure 20 for Homam media data management system.

FIG. 3 is a structural diagram of the Homam system architecture from a security standpoint 30.

FIG. 4 is a sequence diagram depicting the secure pairing process 40 in scope of the Homam infrastructure.

FIG. 5 is a flow diagram of camera key management and content encryption 50 (using the Homam data management system as an example).

FIG. 6 is a flow diagram of secure data provisioning 60 (using the Homam data management system as an example).

FIG. 7 is a flow diagram of client secure data consumption 70 (using the Homam data management system as an example).

FIG. 8 is a HOVSP data transfer diagram including all the main subsystems 80 of the Homam ecosystem.

FIG. 9 is a block scheme of data buffering routine 90 (also employed by the HOVSP protocol infrastructure).

FIG. 10 is a block scheme illustrating the structure of every individual HOVSP atom 100.

FIG. 11 is an XML code representation of the HOVSP stream structure comprising nested hierarchical atoms 110.

FIG. 12 is an entity diagram of HOVSP atoms with dependencies between them 120.

FIG. 13 is a hierarchical tree diagram of HOVSP atoms encapsulated in a complex data stream.

FIG. 14 is a block diagram depicting the high-level VIS structure and its interactions with the outside world.

FIG. 15 is a block diagram illustrating the VIS entity structure and the dependencies between different entities.

FIG. 16 is a block diagram illustrating the detailed VIS component structure together with general interaction flows between components.

FIG. 17 is a diagram illustrating the permanent memory organization (ROM) in scope of the VIS.

FIG. 18 is a block diagram illustrating high-level interactions between VIS components of cache infrastructure (RAM).

FIG. 19 is a block diagram illustrating the memory Allocation operation, including interactions between the External System, ROM and RAM.

FIG. 20 is a flow diagram of the memory Allocation process for new data to be recorded into VIS.

FIG. 21 is a block diagram illustrating the data Translation operation, including interactions between the External System, ROM and RAM.

FIG. 22 is a flow diagram of the data Translation process that exposes data from RAM and ROM.

FIG. 23 is a block diagram illustrating the exemplary B+ tree structure and dependencies between its elements applied to RecordIndex implementation in VIS.

### DETAILED DESCRIPTION OF THE INVENTION

As previously disclosed in the instant application, the invented complex digital media data management platform for the camera is disclosed by the example of the concrete preferred embodiment—Homam media server, including the proprietary implementation of software-defined data storage service VIS and custom streaming protocol HOVSP. However, the same principles and goals may be achieved by employing other methods, algorithms and components, but not going beyond current application.

The Homam system represents the software multimedia server incorporated into the camera apparatus. The system as a whole may be either integrated into a smart home infrastructure or used as the self-contained standalone device. At its core, this is a complex software media server that performs the entire range of operations for registration, processing, storage and transfer over wireless networks of the video and audio data (and some other additional supplementing information like analytics, metadata, etc.). The considered software system can be deployed on any hardware apparatus that satisfies the minimum critical requirements without generality limitation.

Within the scope of the present invention, different technological aspects are considered, from the software media server incorporated into the camera itself to the organizational principles of the supplemental data transfer infrastructure. The significant technical components establishing the operation of the media server and its effective interaction with the end user comprise the protected software-defined data storage service VIS and data streaming protocol (technique) HOVSP. Both mentioned components are proprietary-developed.

The Homam ecosystem architecture includes four main structural components, as follows below:
Homam (camera encapsulating software media server platform and some supplemental technologies)
Cloud Server (serves administrative and validation purposes)
Reverse Proxy Server (transfers the data streams via internet from camera media server to client applications)
Client (end user apps, in the scope of preferred embodiment represented by iOS/Android mobile device applications, consuming content on the user's side and controlling the execution flow by sending requests via the cloud)

The proprietary protocol HOVSP serves as the general technological base, specifying the standard of the entire data processing and transfer workflow in the scope of the Homam media server ecosystem. The camera, as the multimedia processor, registers image and sound by the embedded hardware optical sensors and microphones; the internal analog-to-digital converter then digitizes the raw signal, after that the integrated codec encodes video/audio streams according to selected profiles (the preferred system embodiment employs the AVC/HEVC algorithm for video and AAC for audio, but the invention can be further customized to work with other compression standards). Subsequently, the proprietary multiplexer combines video and audio streams into one single stream, then segments the aggregated stream into fragments according to the custom HOVSP container data format (HOVSP specifies a proprietary data format that is different from widely used MP4 or MPEG2 TS containers). Each audio or video frame of the resulting multiplexed stream is encoded with a short-lived symmetric key (generated on behalf of the camera and not stored openly). Encrypted HOVSP fragments (in other words—atoms) of one and the same unified format are used both for storing data in the permanent memory unit and for transfer over the network.

Traffic, including encrypted content together with the supplemental metadata and crypto information (symmetric encryption keys, each of which is encrypted by the client's public key, and can hence only be decrypted by the client), is transferred over the Wi-Fi or cellular networks by application-level protocols HTTP/HTTPS and/or WebSocket. Herewith either the local network or the specifically arranged Reverse Proxy Server Infrastructure is used.

It is significant to note that HOVSP is an over-the-top (OTT) protocol, works in scope of existing network infrastructure and in some ways is mostly similar to widely used streaming services like Apple HLS and MPEG DASH in operational organization. HOVSP still has some significant features favorably distinguishing it from rivals, especially when it comes to the integration with the camera media server system (namely Homam). For instance, unlike the abovementioned protocols, HOVSP does not need the specific server(s) for content preprocessing (the so-called CDN) before the actual data transfer, as all the content handling and distribution are executed by the media server, encapsulated in the Homam camera system.

The Reverse Proxy Server in the case of the HOVSP protocol serves the single function of traffic routing without any additional pre- or post-processing. The HOVSP client does not need to download any kind of additional metadata before consuming the actual content (e.g. playlist files, as when employing HLS and DASH). It only needs to parse the global stream header containing all the service information about transferred data. This header refreshes on the fly each time any changes in content structure occur. Owing to the optimization of multiplexing/demultiplexing algorithms for data stream and using the proprietary HOVSP container structure with extremely low overhead, this protocol can be effectively used in the context of limited computational power (the number of available processor cores and CPU clock rate, RAM volume) and non-stable network channel.

The software service Verona Index Storage (VIS) associated with the present invention is a proprietary implementation of software-defined data storage system serving for effective writing, storing and reading of data of any arbitrary type or structure. Thanks to leveraging the loop recording mechanism, the preferred embodiment demonstrates the best possible efficiency when used with sequential data structures such as video and audio fragments. But the use of VIS is not limited only to sequential data structures. The system stores the data entirely within one complete memory read/write cycle, after which the information is serially rewritten by a new upcoming data stream. This means that the present invention functions as temporary storage (and the more permanent memory volume is available to the system, the longer the data is stored).

Most VIS components, as will be shown hereinafter, can be altered, supplemented or even replaced with other components of similar structure to customize service behavior according to the concrete usage scenario.

Some of the essential parameters that determine system operation and efficiency can be fine-tuned for specific purposes. For instance, the maximum RAM space usage threshold can be strictly fixed to maintain the balance between system performance and resource consumption. Moreover, it is possible to define the concrete number of CPU cores for service execution (to support parallelism). Other tunable parameters are described further.

The VIS solution architecture defines the essential infrastructure and is independent from the concrete hardware components or the apparatus where the service is going to be deployed. The service can accept an incoming data stream of any arbitrary structure. The system is lightweight and well scalable, which allows its use on different apparatus within a wide range of available hardware resources (RAM, ROM, CPU). As a result, virtually any combination of memory hardware device and applied software data arrangement (file, block, object) can act as the low-level end storage system.

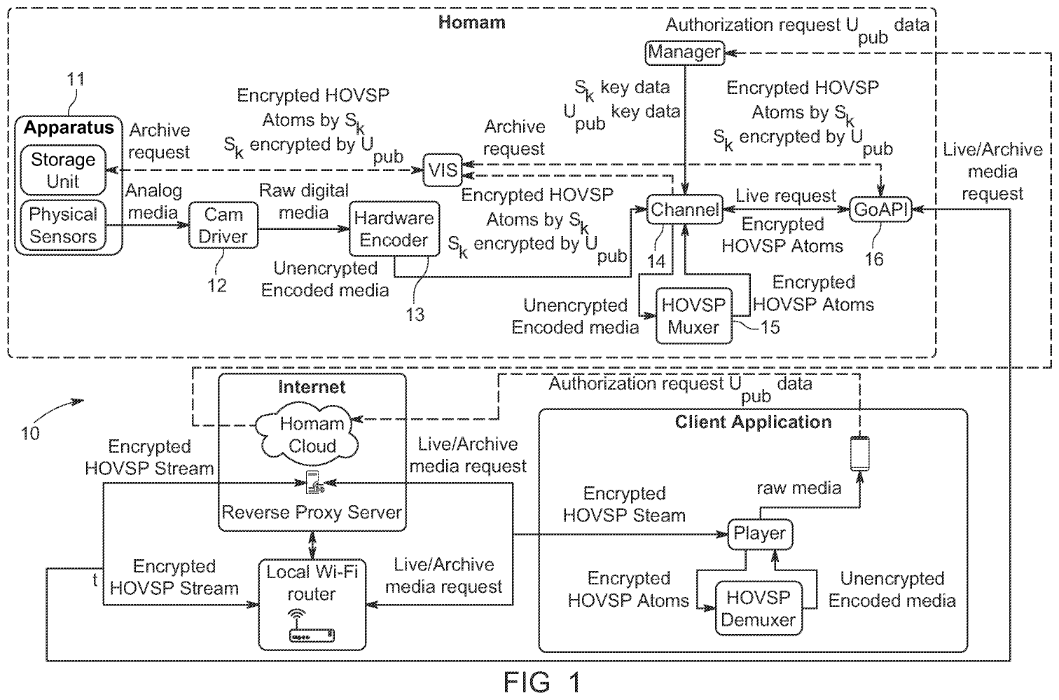

FIG. 1 represents the entire Homam media data management architectural scheme, disclosing the internal structure of some significant components and displaying data streams throughout them. So, the three main composite blocks of the diagram are:
Homam camera
Network infrastructure
Homam client application
   Considering each of the components mentioned above in detail from the standpoint of live stream data registration, network data transfer and further content consuming on the client application side (a solid vector line on the scheme), the following is disclosed.

The Homam component represents the camera 11 with software media server system installed. Here video and audio information is registered by means of the embedded optical subsystem and internal microphones. The “raw” stream of analog data is digitized and processed by the Cam Driver 12 component and further encoded by the embedded Hardware Encoder 13. After that, the stream of encoded data (the preferred embodiment employs the combination of AVC/HEVC codecs for video and AAC for audio, but the HOVSP protocol itself is codec-agnostic in its core) is sent to the internal transport bus component called Channel 14, which encapsulates the multiplexing element called HOVSP Muxer 15. The latter executes all the work in the video/audio data division into segments, combining multiple streams into one single media stream and data encryption. The encryption process uses the short-lived symmetric keys generated and supplied every few minutes (the concrete time value is customizable) by the administrative camera firmware component Manager. Further the stream of encrypted HOVSP atoms flows to the client device (the cell phone with installed application according to preferred embodiment) by means of another internal transport component GoAPI 16 over the network. The network infrastructure is represented by the local network (arranged using the Wi-Fi router) or by internet traffic through a specially organized Reverse Proxy Server system. The communication protocols HTTP/HTTPS and WebSocket (further customization is possible) are used for the client-server communication. The client side in this case is represented by the mobile application Homam and more specifically by the embedded Player component, consuming network traffic in the form of encrypted HOVSP atoms and routing that traffic to the HOVSP Demuxer component, which in turn decrypts content and gives video and audio streams away to the renderer for reproduction on the mobile device screen.

Considering the same infrastructure of the Homam system from the standpoint of content propagation (either live or previously saved) by client application request (a dash vector line on the scheme), the following is disclosed.

The first step of the process is the initiation of the protected session between the client (the cell phone with the Homam application installed) and server (the Homam camera itself) through an authorization request that is sent securely from client to cloud. Before the direct transfer of authorization data, the mobile client generates the private-public key pair according to the asymmetric crypto algorithm (in the scope of the preferred embodiment, the RSA is used, but the present invention is not limited to RSA only). After that the client's private key Uₚᵣᵢᵥ (not actually shown on the current diagram) is securely stored in the protected software storage of the cell phone. The public user key U_{pub} is sent inside the authorization request to the cloud and subsequently reaches the camera (server); it will be used to encrypt the content on the camera side. The receiving component on the server side (Homam camera) is the proprietary software element Manager, which is responsible for the majority of the administrative functions within the Homam ecosystem.

After establishing the secured session between the client (cell phone) and server (camera), the client can send a request to access the content itself (“live stream or archive media request”). The content request by means of network infrastructure (either local network or reverse proxy server via internet) comes to the proprietary internal transport component GoAPI. Depending on the concrete type of the media request, GoAPI forwards it either to VIS (if archive data is queried) or to Channel (to retrieve the live data). In any case the corresponding component (VIS or Channel) transfers the content to internal firmware component GoAPI from where it is forwarded to the client via network infrastructure.

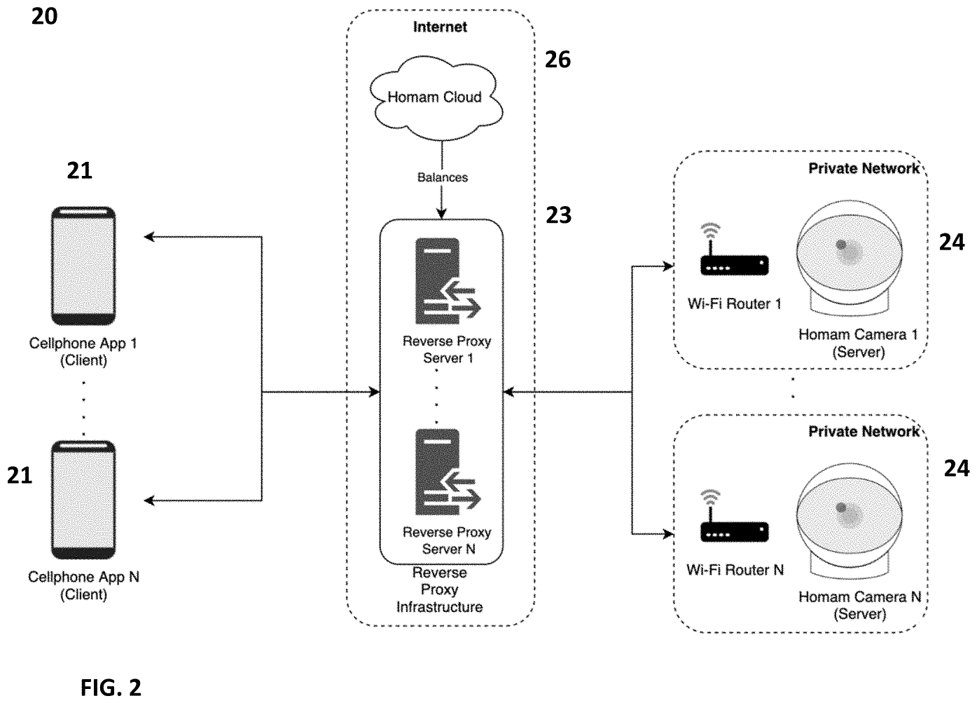

FIG. 2 demonstrates the architectural scheme of the Reverse Proxy Server 23 (in other words the Multi IP system) applied to the concrete preferred embodiment—Homam media data management system. The Reverse Proxy Server is used for content routing via the internet from the media server 24 (Homam camera) to the client (cell phone with the Homam mobile app installed).

The content delivery architecture with the help of the Reverse Proxy implies the existence of the arbitrary number of client and server devices. The client device 21 (cell phone with the Homam app) queries the server (Homam camera) for the data stream according to the scheme considered above in FIG. 1. To obtain the actual content, the client connects to the unified IP address of Reverse Proxy, where the required data was routed from and by the server according to the client request. Internally the Reverse Proxy system comprises several working nodes (either physical machine servers or the logical clusters with different IPs and architecture). Between several instances of Reverse Proxy Server nodes, the content traffic is distributed by the Reverse Proxy system itself and is balanced by the Cloud 26 administrative facility if necessary (based on the client's geolocation data and the current workload of individual nodes).

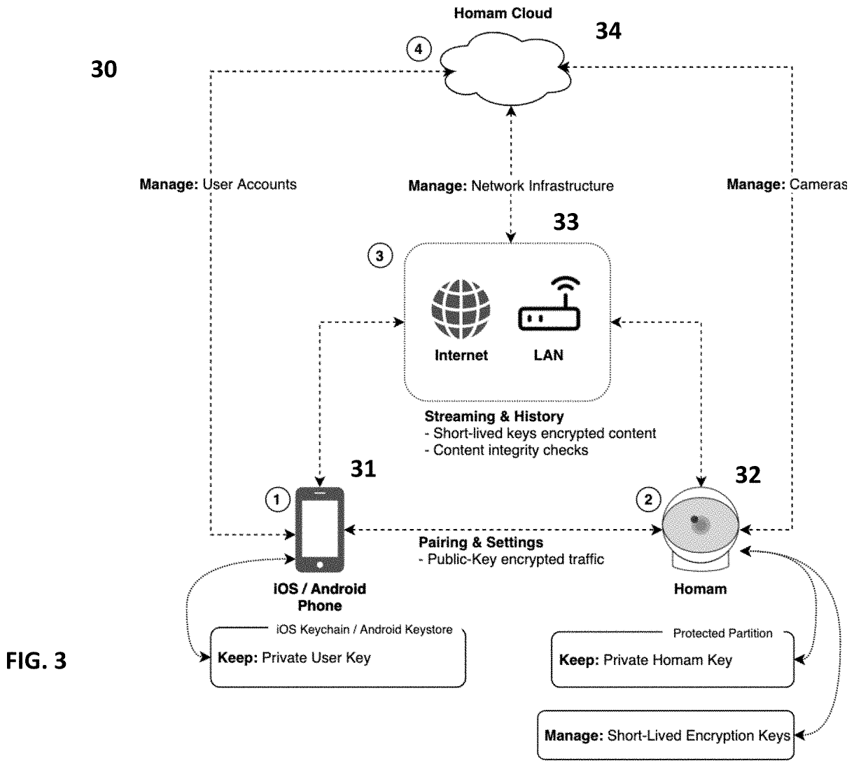

FIG. 3 demonstrates the structural scheme of the Homam media data management system from the standpoint of communications protection and secured data stream transfer between individual components.

Generally the Homam ecosystem comprises four components as follows:
1. Cell Phone 31 with the Homam mobile app installed (client)
2. Homam Camera 32 (server)
3. Network Infrastructure 33 (local network arrangement via Wi-Fi router and Reverse Proxy Server system, considered previously)
4. Homam Cloud 34

The basic scenarios of interaction between the user and the Homam Camera from a security standpoint are the secure pairing procedure and secure streaming and storage. The connections between structural components for all mentioned scenarios are considered below.

Pairing is the operation of binding a concrete Homam Camera to a concrete Homam account. Pairing is the very first action that must be performed with a brand-new Homam, or with a Camera that was manually un-paired before. Completed pairing ensures that all further actions performed with the Camera are performed securely.

Pairing involves the Cell Phone with Homam app installed, Homam Camera and Homam Cloud. Communications between Phone and Camera are performed via Bluetooth; communications with the Homam Cloud rely on the Internet connection.

To maintain the security of the pairing procedure, the following aspects are involved:
1) Camera pre-registration on the Cloud
   Every genuine Homam camera is registered on the Cloud server at the moment of assembly. When a user tries to perform pairing with a specific camera, its identity is validated on the Cloud as the first step of the procedure. If an attempt is made to replace the authentic Homam with any custom camera (or even replace any of its parts with a proprietary module), the pairing procedure will fail.
2) Bluetooth default protection
   According to specifications, starting from version 4.0 Bluetooth Low Energy (BLE) protocol has security support by default. That lays the foundation for the entire secure pairing process. However, the default BLE protection cannot be solely relied on for security.
3) Public key traffic encryption+private keys for secure storage
   Additionally to Bluetooth default protocol security, all traffic between Phone and Camera is encrypted using asymmetric crypto algorithms.
   That implies using private-public key pairs on Phone and Camera while performing data exchange.
   The principle is as follows below:
      Phone always encrypts traffic to Camera (e.g. Content1) using Camera's public key (PubCam). Camera decrypts the cipher message using its private key (PrivCam).
      Camera always encrypts traffic to Phone (e.g. Content2) using the User's public key (PubUser). Phone decrypts obtained cipher message using its private key (PrivUser).
      Public keys are not secret and are known to everyone.
      Private keys are stored securely and never leave their dedicated device. PrivUser is stored in iOS Keychain or Android Keystore (depending on Phone OS); PrivCam is stored in the protected camera partition.
      An intruder able to sniff the channel between Phone and Camera (via Man-in-the-Middle attack) will receive a cipher message encrypted by a specific public key. This message cannot be decrypted without the corresponding private key (at least within a reasonable time).
4) All parties are mutually authenticated.
   All three parties taking part in the pairing process (Phone, Camera, Cloud) are authenticated for each other. This adds another validation layer and eliminates the possibility of illegal component substitution during the process.
5) The Cloud manages and validates the entire pairing process.
   Finally, the Homam Cloud manages the entire procedure and validates its every step. The Cloud exists in one and a single instance and is fully controlled by system administrator engineers. This allows for the timely implementation of appropriate tweaks, if needed.

The process of secure video and audio live streaming from camera to phone and browsing of the previously recorded history are the core functionalities of Homam Camera (software media server system). Both streaming and storage are protected by encryption. The principles used for this purpose are very similar and can be tracked in FIG. 3.

Either live or recorded stream from Homam (2) to Phone (1) is transferred via Network Infrastructure (3) that is managed by the Cloud (4). All content (video, audio and other) is stored only on the Camera and never leaves it (of course, except for the case of record streaming performed using Homam infrastructure).

Some key principles used for maintaining secure streaming and storage are as follows:
All private user content is stored only on the Homam camera.
   The key moment about the considered system security architecture is that all recorded video, audio, and private user settings are stored only in the camera's embedded memory storage. Homam infrastructure does not imply saving or replicating of video to the Cloud. Homam Cloud is used only for system administrative purposes. The only way to access user content is by using the dedicated client app, that is also protected in its turn.
Camera's firmware and storage are not accessible for the end user by the way other than using a dedicated client app.
   For instance, the preferred apparatus embodiment of Homam camera employs a standard USB-C hardware interface, but its single purpose is to provide the power for the device. Of course, the camera can still be physically connected to the computer using the USB-C cable, but its internal memory or software won't be accessible by any standard tools as additional protection facilities are applied and the internal storage is overall encrypted.
All user content is encrypted by a sequence of short-lived encryption keys.
   The camera generates the new encryption key each couple of minutes (the concrete time period is configurable) and ciphers all private user content with this key until the next one is generated. This process is constantly repeated. An intruder who gains access to one key (that's still very hard to perform) will be able to decrypt and gain access to a very small amount of content within a few minutes, until the next key is generated by the camera.
Encryption keys are never stored openly.
   Each of the keys from the sequence of camera-generated short-lived encryption keys is stored ciphered by the user's public key. A malefactor who even gains physical access to the camera won't be able to decrypt the keys sequence and access the actual content (because the user's private key needed for decryption is kept in the phone's secure storage).
The stream transmission mechanism implies data integrity checks.
   Every single message from the Phone or Camera is checked for integrity on the other side. If an intruder infiltrates the traffic in any way, this fact will be detected and the other side will take proper action.
The Cloud server manages and validates the entire process.
   Just like for pairing procedure, the Cloud provides high-level management and validation for the entire process of live streaming or browsing of the recorded history. If something goes wrong or is just suspicious from any point, the infrastructure administrators can immediately come into play and perform manual on-the-fly tweaks.

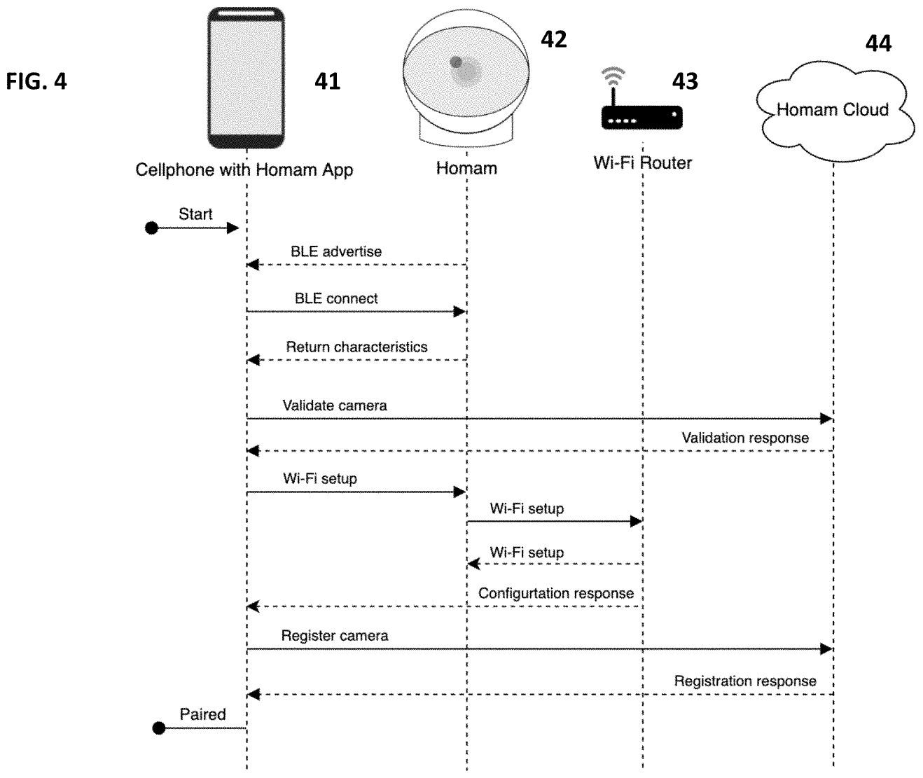

FIG. 4 demonstrates the simplified sequence diagram of the Secure Pairing process between the cell phone 41 and the Homam camera 42 by means of the Cloud server (that executes administrative operations).

This process is essential for the entire workflow of the interaction between user and camera, because it allows the execution of mutual authentication between the devices with cloud verification for the further secure traffic transfer over the internet.

The pairing process is initiated by the Homam mobile application installed on the cell phone. Herewith the mobile app uses the Bluetooth connection to extract the data needed for the further procedure from the BLE advertising payload:
Paired flag—shows if the currently queried Homam camera is already paired (bound to concrete Homam account) or free
Serial number—the serial number of the concrete Homam camera
Model—the model info about the concrete Homam camera

Using all the aforementioned information, the application connects to the concrete Homam camera (BLE connect). Camera again returns its characteristics, needed to continue the pairing process, as part of the response (Return characteristics). The mobile client sends a request to the cloud to validate a concrete camera on the cloud, taking into account the data gained from the BLE advertising payload. The cloud then validates the camera according to the data from the mobile client (while verifying its notes about valid Homam cameras). If the selected camera is accepted as valid, the mobile client sends it a request for Wi-Fi network configuration execution. The camera then queries the available Wi-Fi routers and connects to one concrete selected router with permission from the mobile application. Then the mobile client initiates the registration of the selected camera on the cloud in order to bind the concrete Homam account to the concrete camera. If the camera is successfully registered on the cloud, the process is finished.

The important thing about Homam system security architecture is that its content encryption and its transfer over network channels is still treated as potentially insecure. To serve security purposes in such a case, the camera generates a new short-lived symmetric key every few minutes and uses it to encrypt all incoming content. The symmetric key itself is never stored on the camera openly, but is encrypted by the client's public key, obtained from the mobile application and saved on the camera during the secure pairing process considered in the scope of FIG. 3 above. When content is requested by the client, the symmetric-key encrypted data is sent alongside with the key itself (previously encrypted with the client's public key). As a result, on the receiving side, the client application firstly decrypts the symmetric key using its private key, then decrypts the obtained content itself using the elaborated symmetric key. The individual aspects of the described processes are considered in detail hereinafter.

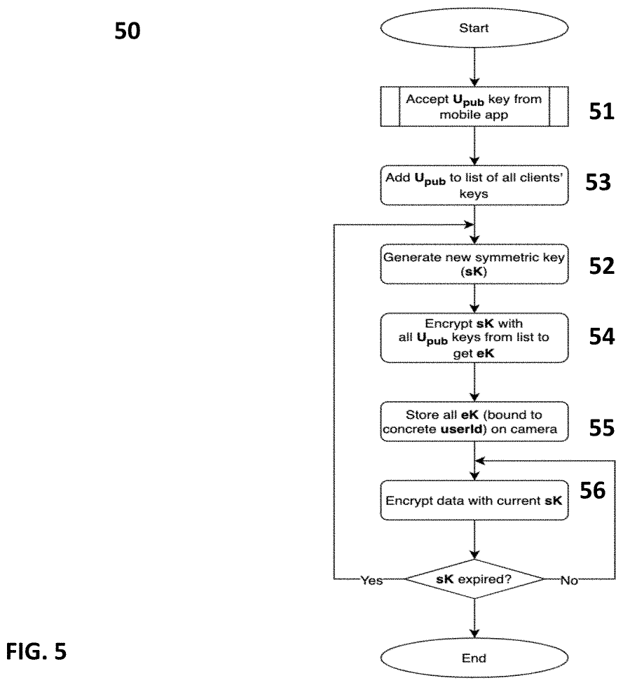

FIG. 5 demonstrates the simplified flowchart of cryptographic key management and content encryption 50 on the camera side.

The first step of the process is the receipt of the user's public key U_{pub} by the Homam camera 51. The obtained key is then saved in the common list of all public keys 53 for all client devices connected to the camera (for multi-user access, there is naturally more than one such public key).

Every few minutes (the concrete time value is customizable) the camera generates a new symmetric key sK 52. The next step is the encryption of the generated symmetric key sK by all public keys U_{pub} previously saved on the camera for getting the encrypted symmetric key eK 54. After that all encrypted keys eK are also saved on the camera 55 for further transmission as part of the encrypted content to the client.

Finally the encryption itself is done using the current actual symmetric key 56. When the key expires, the camera generates a new symmetric key sK and the entire procedure is repeated from the beginning.

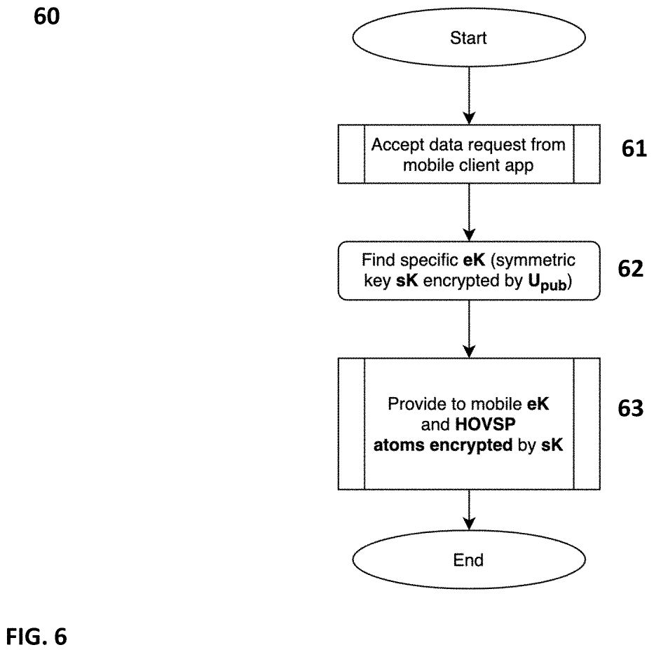

FIG. 6 demonstrates the simplified flowchart of the further transfer of encrypted content over the network from the camera media server side.

The camera receives the request 61 from the client mobile device for content provisioning, finds the specific symmetric key eK 62 (or multiple keys), encrypted by corresponding client's public key, and sends the symmetric-key encrypted traffic in the form of HOVSP atoms 63 (considered in detail hereinafter) and attached encrypted keys eK.

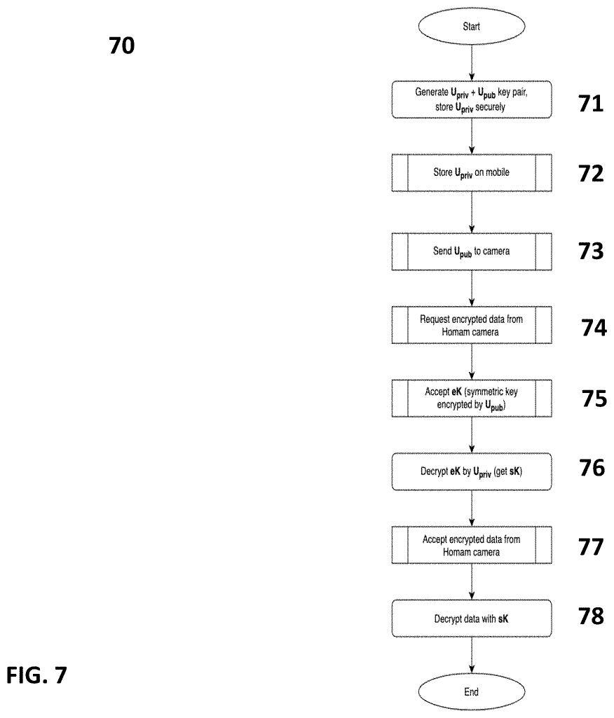

FIG. 7 demonstrates a simplified flowchart 70 of the encrypted content consumption on the client device.

The preparatory step for the consumption of content is the initial generation 71 of the user's private-public asymmetric crypto key pair Uₚᵣᵢᵥ and U_{pub}, wherein the Uₚᵣᵢᵥ key is securely kept inside protected software storage of the mobile device 72 (for Android it is KeyStore; for iOS this is Keychain).

Thereafter, during the secure pairing procedure, considered previously in the scope of FIG. 3, the cell phone sends the public user's key U_{pub} to the camera 73.

Then, at a certain point in time, the mobile application sends the request for content 74 to the Homam camera. As a result, using the network infrastructure (either local Wi-Fi traffic or Reverse Proxy Server via the internet), the camera returns to the client application the content traffic in the form of encrypted HOVSP atoms with attached symmetric keys, in their turn encrypted with U_{pub} 75.

The process of content decryption 76 on the client side implies the receipt of eK 77 (symmetric key encrypted with public user key U_{pub}), the decryption 78 of that key with private user key Uₚᵣᵢᵥ and the decryption of the content itself using the elaborated symmetric key sK.

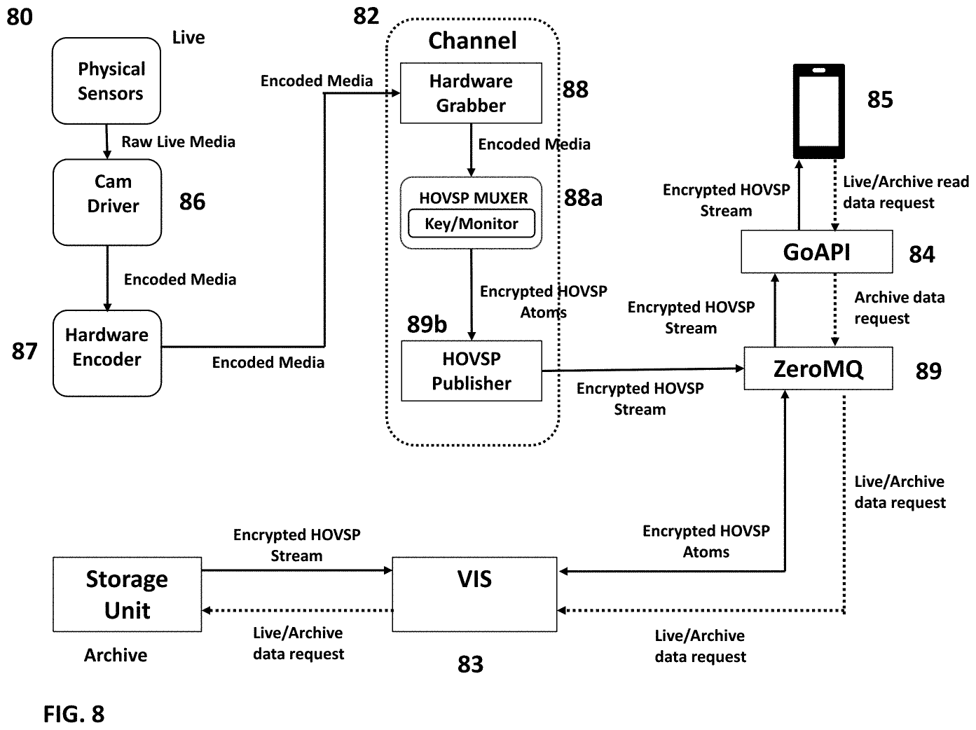

FIG. 8 demonstrates the block scheme of data transfer between various components according to HOVSP infrastructure.

The two main general blocks (components) responsible for content provisioning are the Physical Sensors 81 (optical lenses and camera microphones) and the embedded camera flash memory Storage Unit, containing the recorded data archive. The other internal proprietary components displayed on the scheme are Channel 82, VIS 83 and GoAPI 84.

Channel 82 represents the internal data pipeline inside the camera software ecosystem, where all the live content goes and from where it follows to clients' devices over the network infrastructure. VIS 83 is the proprietary software-defined data storage system (in other words, the custom database implementation). GoAPI 84 in its turn represents the specific transport layer that links the client (cell phone) and server 85 (camera).

Considering the live media data transfer flow from the moment of its registration by the camera's physical sensors to its recording into the camera's internal memory and actual delivery to the client device (this data flow is depicted in the diagram by the solid vector line).

The lenses and the microphones, embedded into the camera hardware construction, register the analog media data (image and sound) on behalf of the Cam Driver 86 component. The Cam Driver digitizes the analog data acting as the analog-to-digital converter, after which the flow of “raw” digital data is sent to embedded component Hardware Encoder 87, which encodes and compresses information according to different selected algorithms (for instance, the preferred embodiment employs the AVC/HEVC for video and AAC for audio, but customization is available). The encoded data stream is then transferred to the internal pipeline component Channel 82 (more specifically to the Grabber 88 subcomponent). The Grabber component is responsible for extracting the encoded content streams according to applied configs.

The encoded, but still separated, video and audio streams are conveyed to the component HOVSP Muxer 88a for further processing. The HOVSP Muxer performs the segmentation and streams multiplexing to one single media stream according to the specified proprietary HOVSP container data format (which is considered in detail hereinafter). In addition, the HOVSP Muxer performs the encryption of every obtained data segment (atom, in other words) using the symmetric key that is incoming into the subcomponent KeyMonitor from the outside (actually from the Manager component, covered in FIG. 1; further details are not considered in the scope of the current scheme). The encrypted HOVSP atoms are then sent to the intermediary component ZeroMQ 89 serving as the internal data bus of the Homam camera. From there, the atoms follow in two directions: through the proprietary GoAPI 84 component over HTTP/HTTPS and WebSocket protocols to the mobile client and through VIS they are recorded into the camera memory Storage Unit. So, the same data stream is both presented as the live stream on a mobile device screen and stored to the internal memory in the form of an archive for further access to information from the client.

Considering what happens to the data stream upon request to access the live stream or archive from the mobile client side (this flow is depicted on the scheme with the dash vector line).

The data reading request goes from the mobile client application to GoAPI component, from where it comes to VIS through the internal bus ZeroMQ. As VIS encapsulates all the functionality of working with the internal permanent memory (data writing/reading), it queries the memory unit directly and gains the required data. The extracted content in the form of encrypted HOVSP atoms follows the mobile client in the reverse direction.

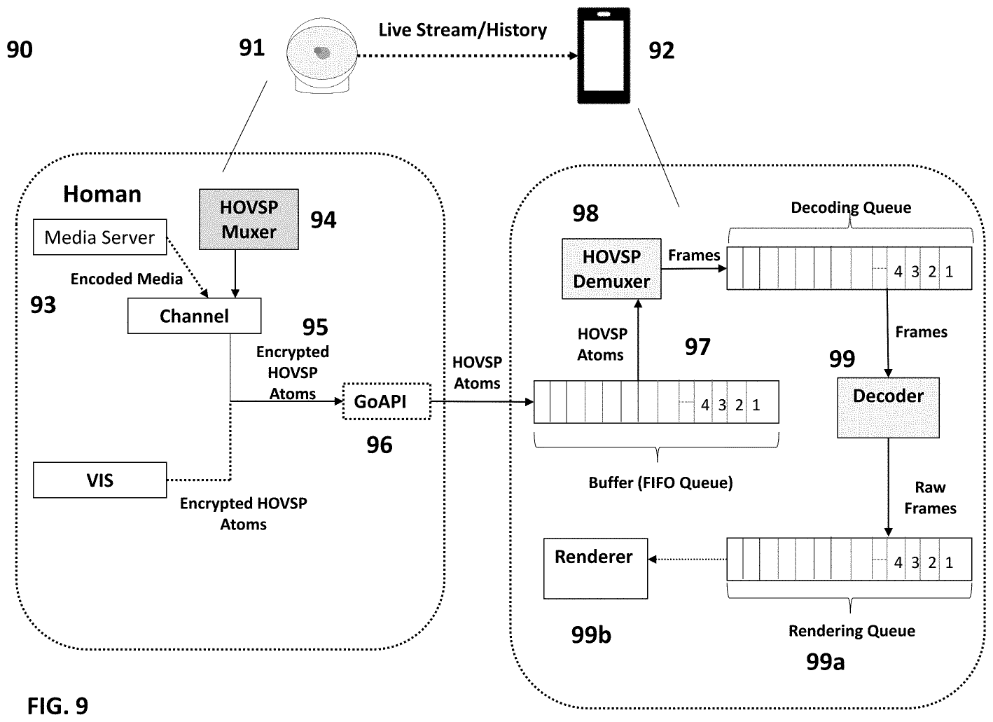

FIG. 9 depicts the detailed data buffering scheme 90 in the scope of HOVSP protocol usage applied to Homam media data management system infrastructure.

The two parties of the data transfer process are the Homam camera 91 itself and the mobile client application Homam 92 (more specifically its subcomponent Player). Actually, in the scope of the consideration of the buffering process, it is not important which serves as the data source. The main sense is carried out by the buffering organization from the standpoint of the preparation of data transfer (by camera) and data consumption (by the mobile application).

The Homam camera as the media server can translate the live data stream employing either internal firmware component Mediaserver 93 (which registers data directly from the camera's physical sensors and gives it away in encoded form) or the archive data stream employing the proprietary VIS component (which reads the previously saved data from the internal permanent memory and gives it away in the form of encoded HOVSP atoms). Coming to the internal pipeline component Channel 95, the live stream the data is segmented and encrypted, and the archive stream remains unchanged (as the storage already keeps data in the necessary format of encrypted HOVSP atoms, which are then extracted and transferred by the VIS component). After that, the data stream, consisting of the encrypted HOVSP segments (atoms) through the proprietary component GoAPI 96 (providing traffic transport over the application-level OSI protocols HTTP/HTTPS and/or WebSocket), flows to the Homam mobile application. Consideration of the part of network infrastructure that connects the camera (server) and the cell phone (client) is omitted, because it was considered in previous figures. The process of HOVSP atoms' progress after they arrive at the Player component of the mobile client application is addressed.

When the network connection is stable enough (without disconnections, timeouts, etc.) the data buffering on the client side occurs one single time at the very beginning of the streaming process (regardless of whether the footage is live or archived). After the client accumulates a certain amount of data in the buffer 97 (the concrete value is adjusted in the application source code and, in the scope of the preferred embodiment, is set to 1 Group of Pictures (GOP)=30 frames for 30 FPS) the bufferization is disabled until it is next needed. Once the initial buffering is finished (i.e. after the amount of frames needed to fill the buffer is downloaded from the server to the client) the stream then starts on the client device. In that way, the stream quick-start is implemented in the HOVSP infrastructure (for the video-on-demand) and with low latency (in the preferred embodiment implementation, for the live stream, the delay between the image and sound in real time and its counterpart representation on the client screen is about 1-3 s).

The encrypted HOVSP atoms are then consumed by the HOVSP Demuxer 98 component directly from the prepared buffer (rather than downloading each concrete frame) according to the queue FIFO principle. The HOVSP Demuxer performs the decryption of incoming atoms and separation of video and audio streams. After that the individual frames (encoded according to algorithms AVC/HEVC and AAC in the scope of the preferred system embodiment) continue to the Decoding Queue 98a. This queue has a changeable size depending on system operation:
with a stable network connection and normal system operation, the queue size is between the lower and upper Buffer limit values;
when there are network connection problems, obviously, the size of frames queue for decoding would exceed the upper Buffer limit, so additional steps to normalize the process are needed (playback speedup and buffer size adjustment).

From the Decoding Queue the frames come to the Decoder 99 element, and from there go to the Rendering Queue 99a, which is finally consumed by the Renderer 99b component. The principle of work organization towards the Rendering Queue is conceptually the same as for the Decoding Queue.

Also considering the bufferization arrangement of client size in case of network problems or loss of connection between the phone and the camera for whatever reason. In that case the buffering processing is started when all data from the Rendering Queue is already processed (displayed on a mobile device display), but the new packets are not delivered, i.e. the Rendering Queue is currently empty. For the Player component to work normally, the sizes of packet queues such as the Decoding Queue and Rendering Queue must be between the lower and the upper limits for the Buffer size. Buffer limit values are calculated during system operation and adjusted in case of queues going out of expected bounds. The starting values for Buffer lower and upper limits are set at the moment of Player initialization (as it was previously stated for the initial value of upper Buffer limit the number of 30 frames=1 GOP is used). During the Homam system execution, the bounds are being constantly adjusted in the HOVSP Demuxer component based on current data and information processing dynamic within the Player.

Considering the formed feedback, the lower bound of the Buffer size slowly decreases if its value exceeds the sum of packets in the Decoding Queue and currently decoded packets in the Rendering Queue, or it is set to initial value otherwise. The upper bound is set according to the calculated value of the lower bound plus the margin between max and min values of Decoding and Rendering Queues. After buffering ends (when the stable network connection is restored), bound sizes are averaged based on delta between current values (before buffering started) and the number of accumulated frames. So the number of frames available for the Player must always fall into the adjusted bounds. Otherwise the limits correction mechanism for the Buffer is re-executed.

After detailed consideration of the infrastructural aspects of the data transfer in the scope of the Homam ecosystem and the invented HOVSP protocol (camera—media server, Reverse Proxy Server system, mobile client) the more low-level detailization of the HOVSP structure units is considered. In particular, in the scope of upcoming schemes, consider the proprietary HOVSP container format. It specifies the organization of data stored in permanent camera memory and transferred over the network data in the form of segments (atoms) having a strictly defined structure.

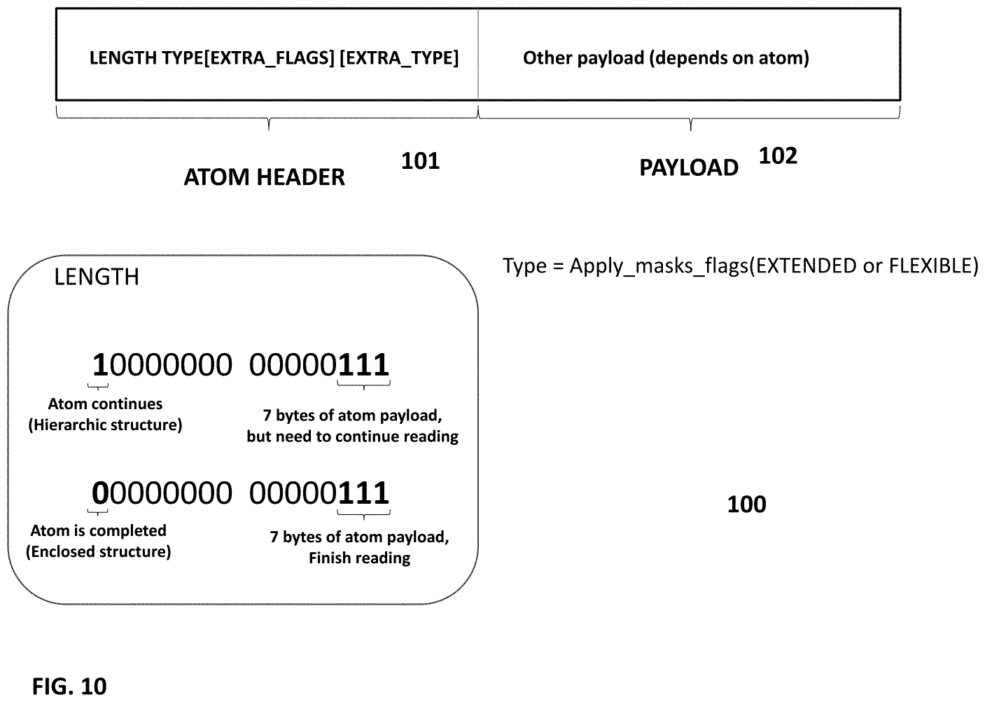

FIG. 10 demonstrates the structure block scheme of each individual atom in the scope of the invented proprietary data container format HOVSP. The HOVSP atoms represent the individual structural unit of transferred and/or stored data across the entire Homam media data management system. One atom is the bit sequence, encapsulating the media data (video and audio frames) and supplemental metainformation. The atom size is not fixed, but is strictly defined in its header.

The structure of any HOVSP atom implies the presence of two mandatory bit blocks: HEADER 101 (describes the type of data the current atom holds) and PAYLOAD 102 (the atom content itself). The header contains the service metadata (and only metadata) about atom structure and content; the actual payload may include either other nested atoms (following the hierarchical principle), or the media content itself in the form of individual audio and video frames. Let's consider each of the structural blocks mentioned above in detail.

HEADER includes the following elements:
LENGTH (2 bytes) is, according to its name, the block of atom header holding its actual size in bytes. Herewith the first bit of the LENGTH block represents the flag if the current atom contains a hierarchical structure or just holds the actual content payload without any intermediary elements. So, the maximum size of one concrete atom according to the preferred embodiment is 2¹⁵=32,768 bytes. However in most cases the size of the actually used HOVSP atoms rarely exceeds a few dozen bytes.
TYPE (1 byte) is the block representing the short 1-byte type of current atom. The concrete value for this byte is calculated based on the actual atom data type and additional bit flags of atom. In the scope of HOVSP paradigm there are several atom types exist:
   Extended (Reserved)
   The extended atom type represents the reserved constant 2-byte value, predefined and known to both the transmitting side (HOVSP Muxer on behalf of the camera media server firmware) and the receiving side (HOVSP Demuxer component on behalf of the mobile client application). Extended type atoms transfer only service metadata.
   Flexible (Non-Reserved, Self-Describing)
   This atom type has a 1-byte value, which can change during the data transfer process (the concrete bit value for that type is set in the data stream header, as will be demonstrated further). Flexible type atoms transfer media content frames.
   Short (Calculated using Masks and Flags)
   The shortened 1-byte atom type is calculated from the Extended or Flexible type by applying specific masks and type flags (if the current atom contains them). Exactly that shortened type value is placed into block TYPE of the atom's HEADER.
EXTRA_FLAGS (1 byte) is the optional header's block, containing additional atom flags (if the atom has some). For the receiving side (the HOVSP Demuxer component) to understand if the mentioned block is present in the header of a concrete atom, the specific bit mask is applied to the previous block TYPE value.
EXTRA_TYPE (1 byte) is the optional header's block, calculated specifically for Extended-type atoms only. To verify the presence of the mentioned block in the atom header, the special bit mask is applied to the previous block TYPE value.

The HEADER atom (holds metadata about the current atom) is directly followed by the PAYLOAD atom (holds either the atom content itself or the other nested atoms following the hierarchical principle).

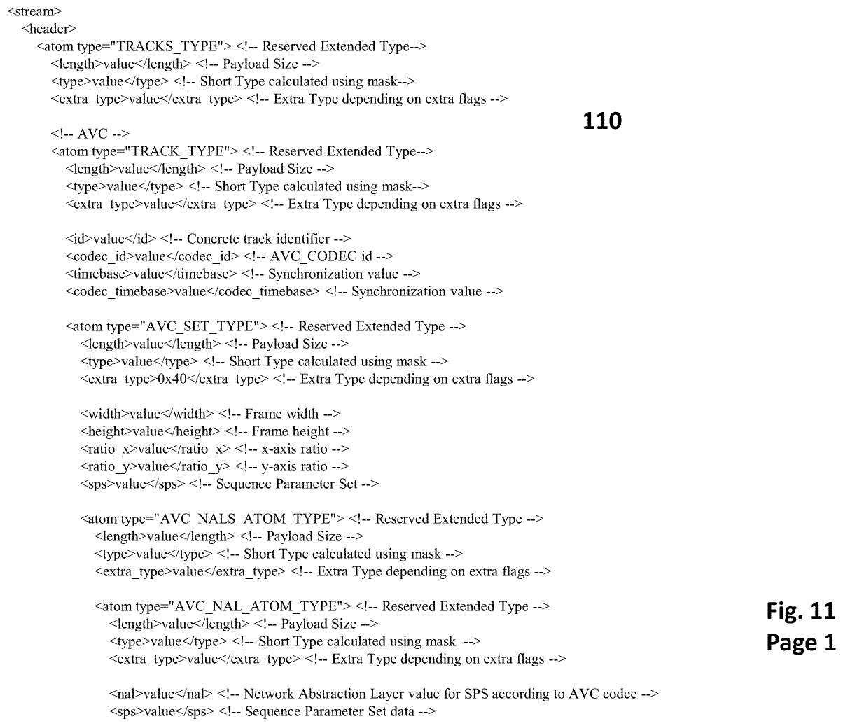

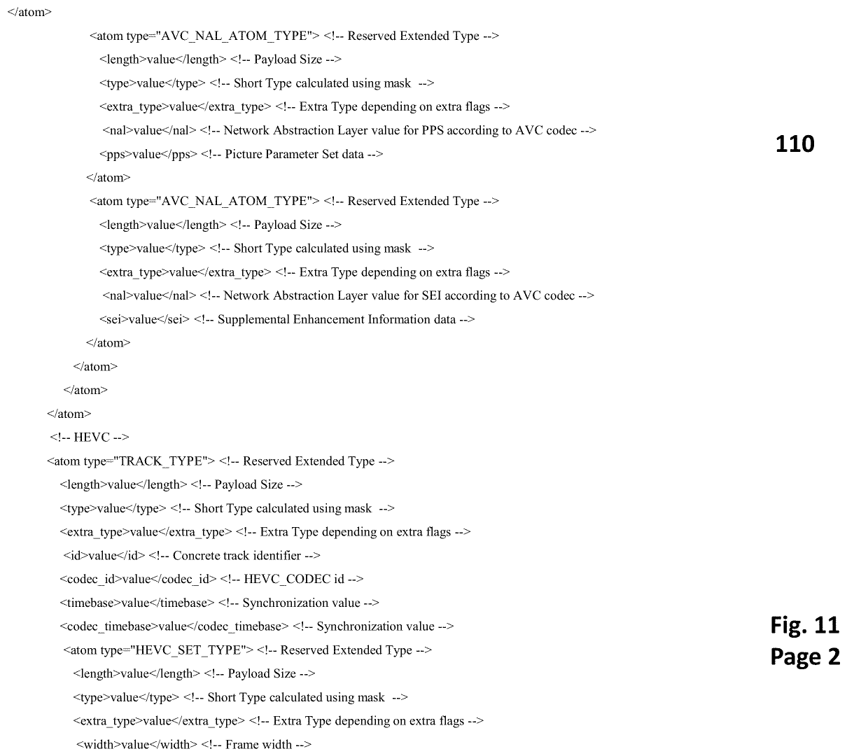

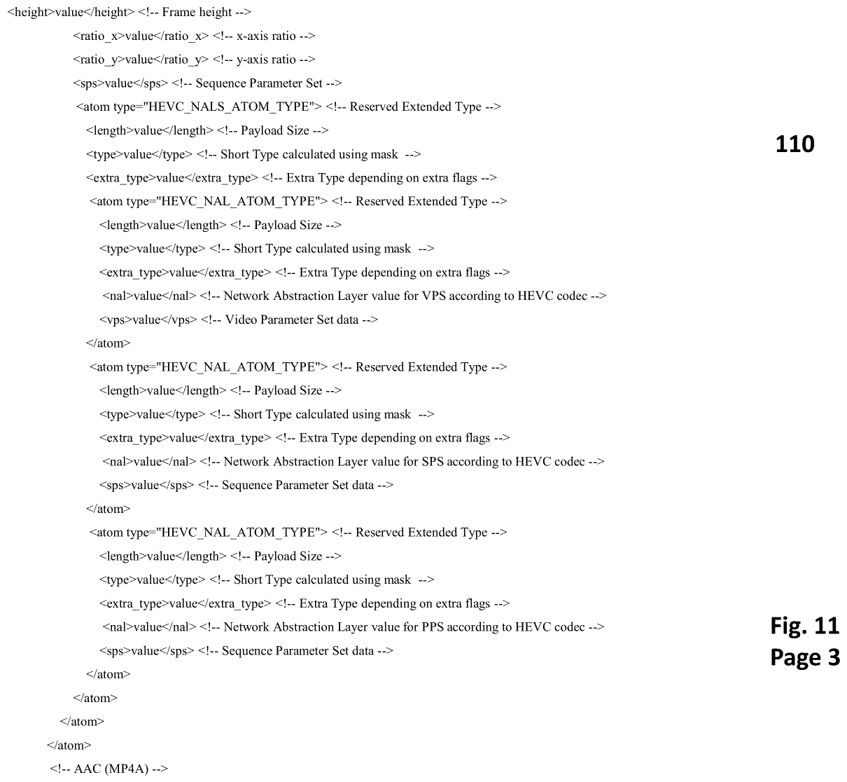

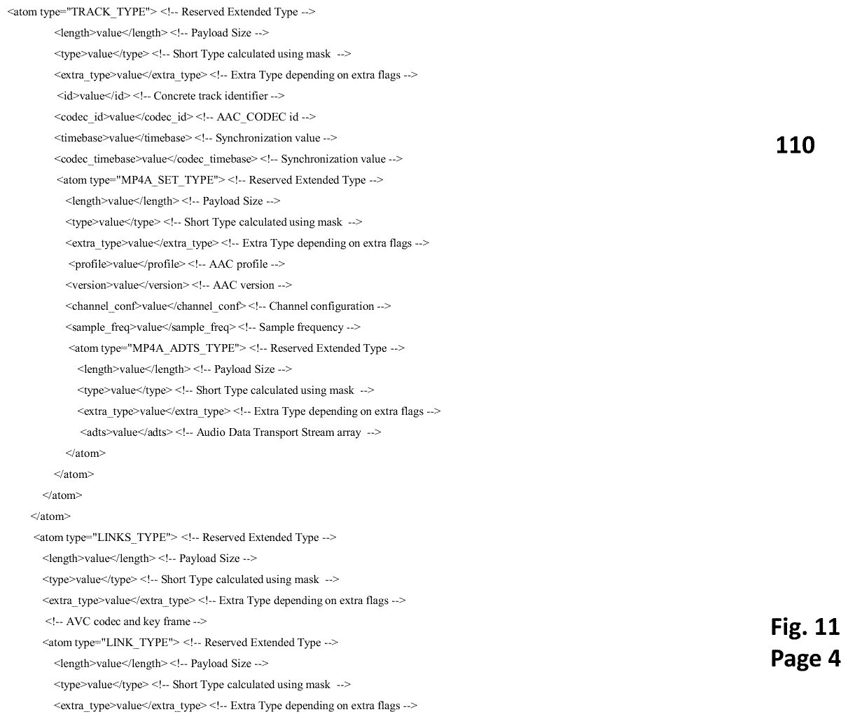

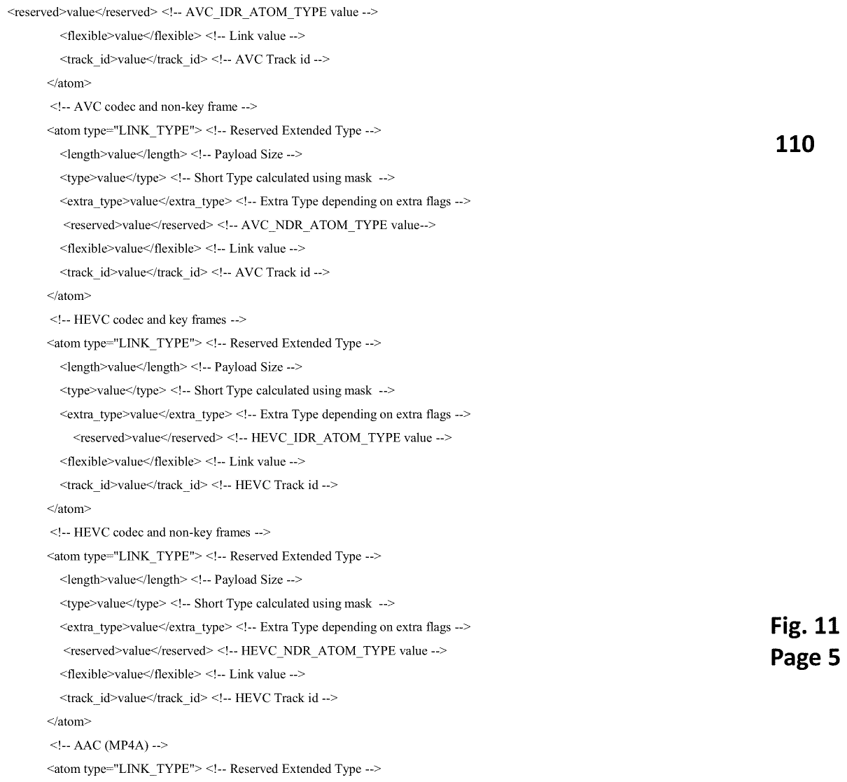

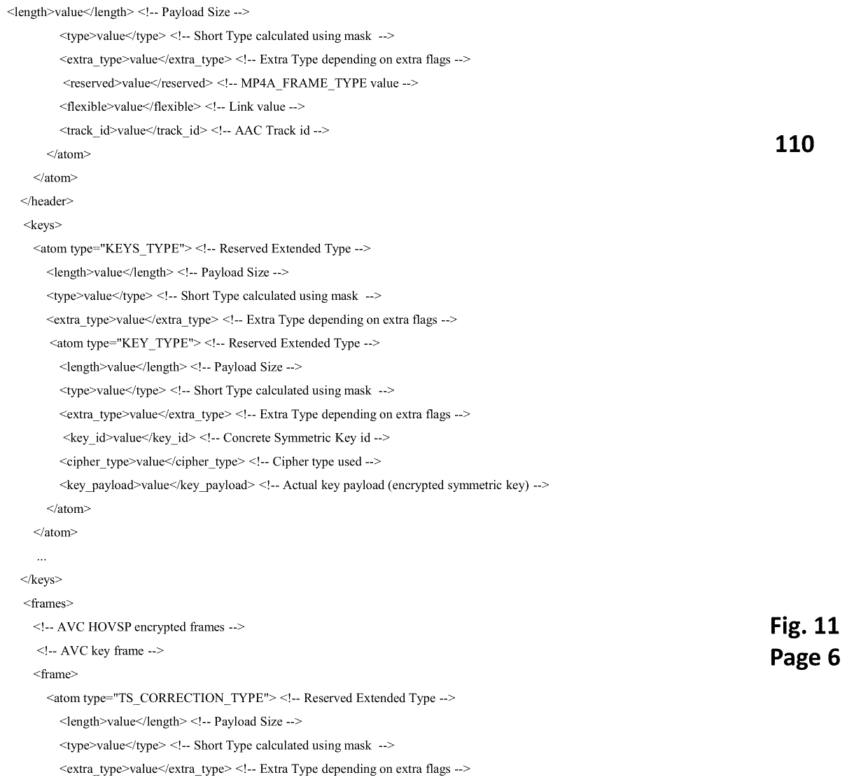

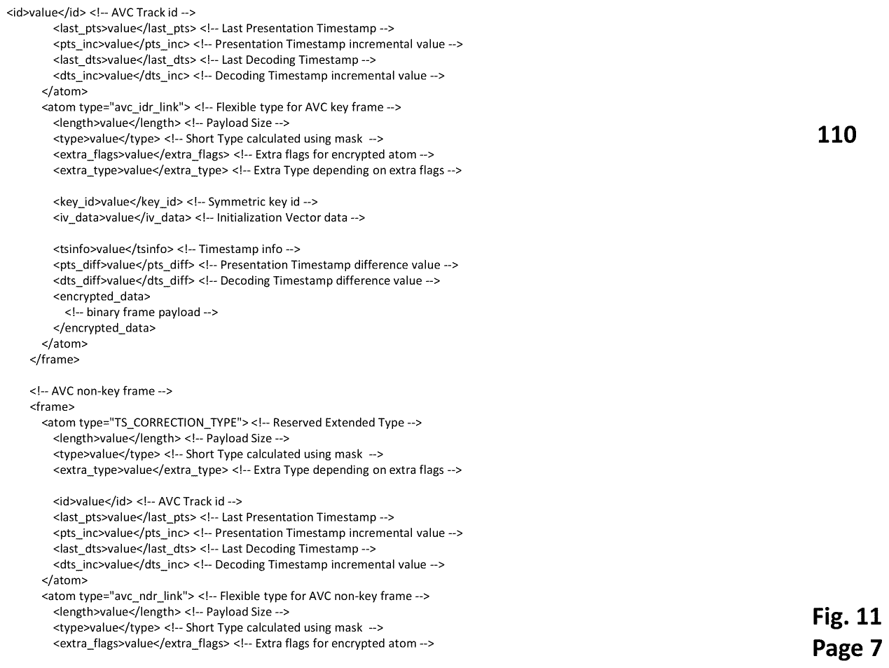

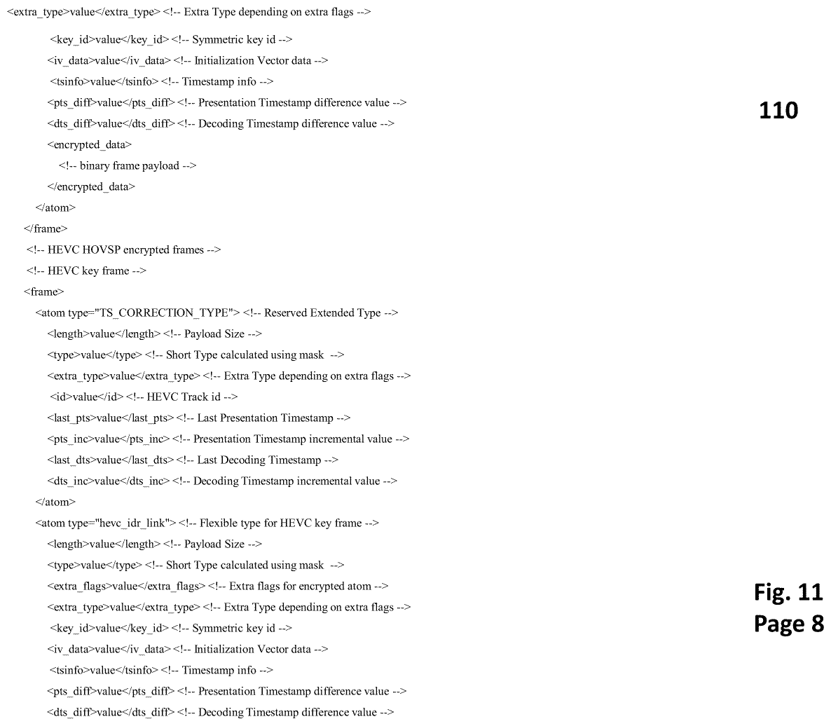

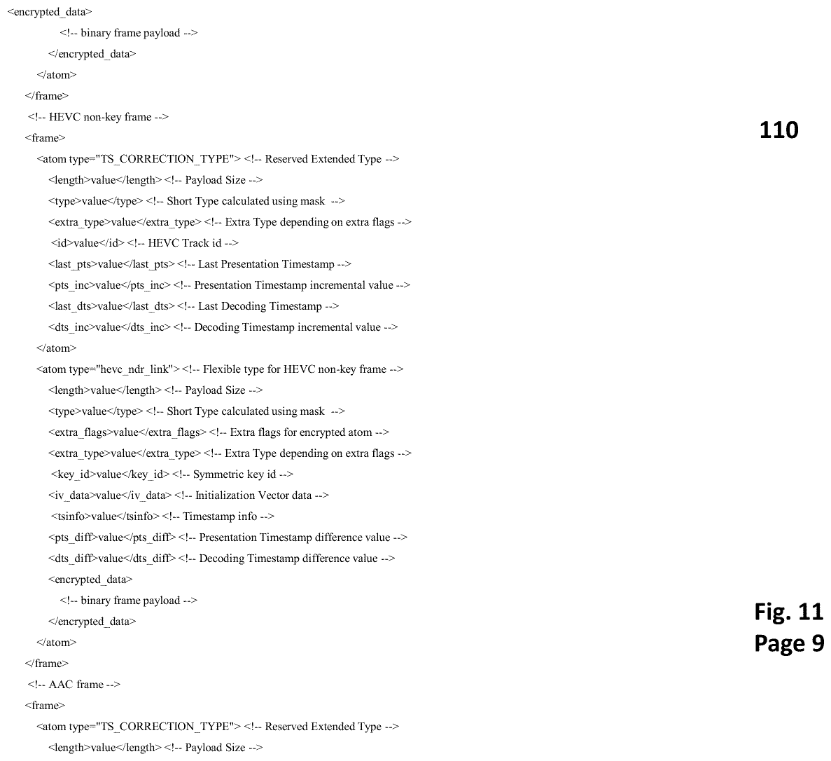

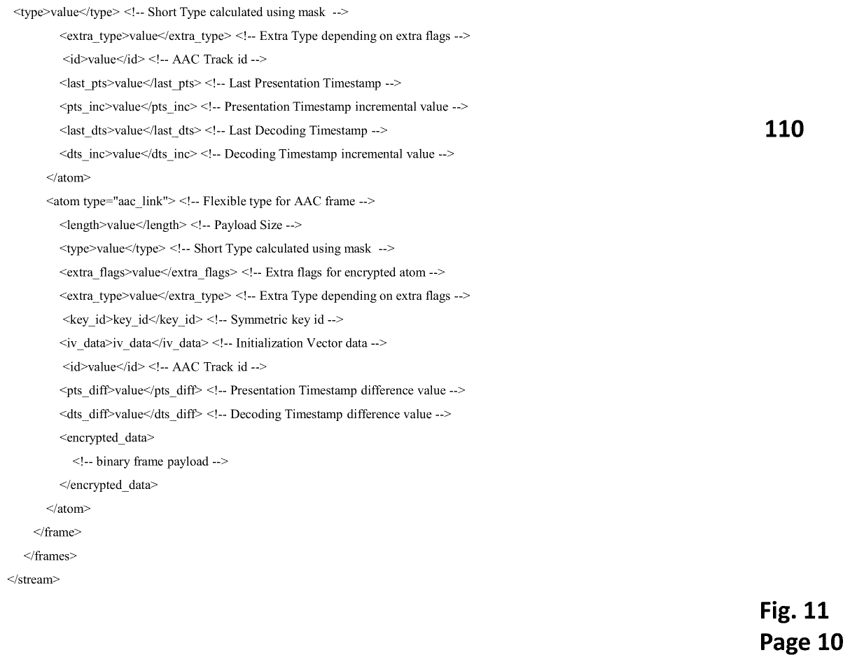

FIG. 11 demonstrates the XML, representation 110 of the HOVSP data stream structure. It is important to mention that the given representation is simplified and very much fictive, because the data transfer process in the HOVSP paradigm does not use XML (bitstreams are employed instead). However, XML code is more easily read by human, and clearly demonstrates the hierarchical structure of atoms, which is why this type of representation has been selected.

Analyzing the hierarchical structure of the HOVSP data stream, consisting of atoms, nested into one another, using the XML code fragment on FIG. 11. The significant information is as follows.

The HOVSP stream is actually the hierarchical structure having the form as shown below (uppercase letters indicate the names of real HOVSP atoms; lowercase letters are used for fictive tags/wrappers added for better readability and to make the resultant structure more ordered):
header—This is actually the header of the entire data stream, formed and transferred to the client each time the configuration of any element of the stream is changed. The stream header is cached by client and if there are no changes in the stream for a while, the server does not resend the header again (which avoids traffic overhead).
   TRACKS TYPE—Reserved Extended atom, encapsulating metadata about all tracks available in the HOVSP stream.
      TRACK TYPE—Reserved Extended atom, holding metadata about one single concrete track. A track is an individual specifically configured video or audio track having its own technical attributes, such as applied codec, bitrate, etc. In the scope of the preferred embodiment, there are three track variants available (each of them encapsulates the concrete stream metadata specific for the certain encoding algorithm, e.g. HEVC/AVC/AAC), as seen below:
         HEVC_SET_TYPE
         AVC_SET_TYPE
         MP4A_SET_TYPE
   LINKS_TYPE—Reserved Extended atom, encapsulating the links between the tracks' service metadata and the actual content.
      LINK TYPE—Reserved Extended atom, encapsulating the table for one individual link between the concrete track and the media data itself (for various codecs of video AVC/HEVC and audio AAC).
keys—This section transfers the sequence of cryptographic keys in the HOVSP stream, and is needed for client-side content decryption.
   KEYS TYPE—Reserved Extended atom, encapsulating the collection of individual cryptographic keys.
      KEY TYPE—Reserved Extended atom, encapsulating one concrete cryptographic key. Besides the mandatory header, this atom contains the next attributes as follows:
         key_id—the unique identifier of the concrete individual key amongst all the keys transmitted by the HOVSP protocol
         cipher_type—the key size according to the selected encryption type
         key_payload—the value, holding the symmetric key encrypted by the public user's key. The symmetric key is generated on the camera side and used for encrypting the actual content of the HOVSP stream
frames—This section of the HOVSP stream transmits the actual encrypted atoms.
   frame—a block encapsulating the individual HOVSP atom (holding the concrete media frame)
      TS_CORRECTION_TYPE—Reserved Extended atom, containing metadata, needed for frame synchronization within one track and different tracks between each other.
      avc_idr_link/avc_ndr_link/hevc_idr_link/hevc_ndr_link/aac link—Flexible atoms, the concrete value of which is set in the block LINK TYPE of the stream header. Each of these atoms encapsulates one audio or video frame and some additional metadata:
         key_id—the unique identifier of the cryptographic encryption key for finding the concrete value from the KEY TYPE section of HOVSP protocol
         iv_data—the value of the initialization vector used for launching the decryption procedure on the client side
         track id—the unique identifier of the concrete media track, corresponding to that in the stream header
         pts_diff/dts_diff—the specific data for the synchronization of media frames by PTS (presentation timestamp) and DTS (decoding timestamp)
         encrypted_data—the actual encrypted data for a concrete audio or video frame

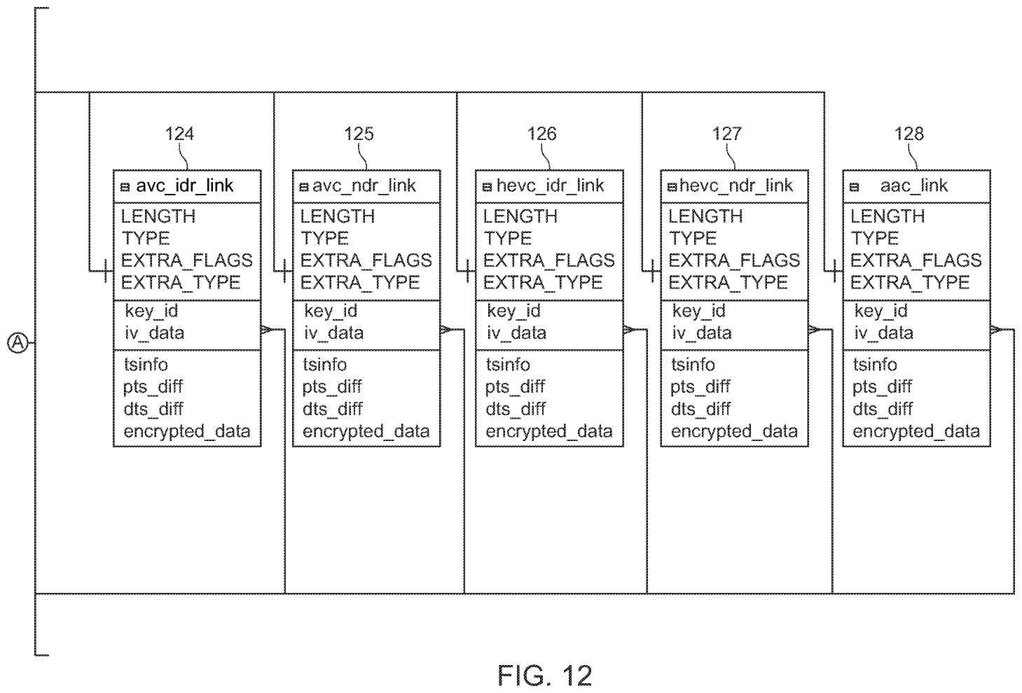

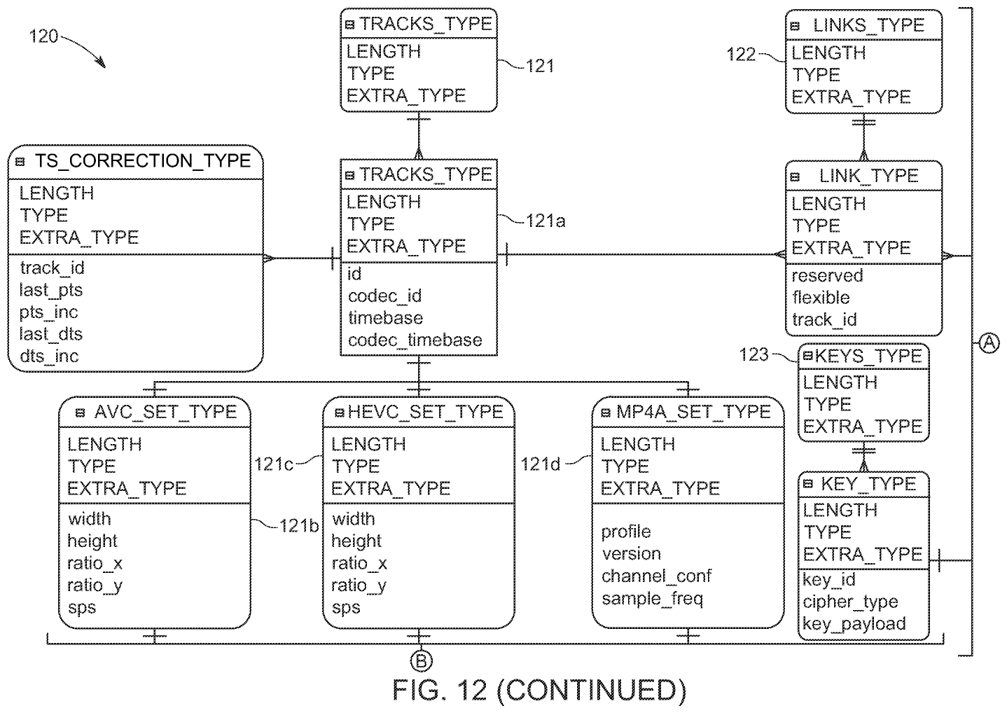

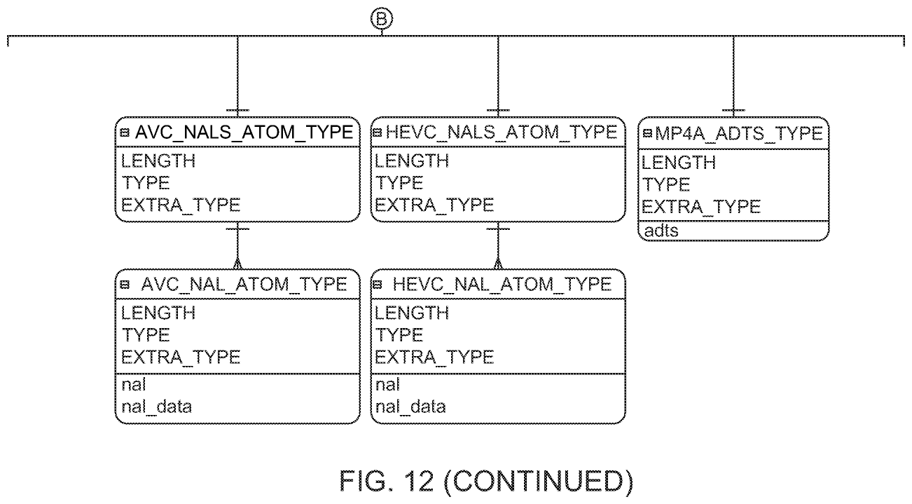

FIG. 12 employs the descriptive form of entity relationship diagram 120 to demonstrate the logical connections between the main atoms of the HOVSP structure.

The three main atom types defining the corresponding content blocks of HOVSP stream are TRACKS_TYPE 121, LINKS_TYPE 122 and KEYS_TYPE 123. Each of the content groups is considered below.

The Reserved atom TRACKS_TYPE contains the collection of TRACK TYPE 121a atoms, each of which encapsulates metadata about one concrete media track (audio or video). The HOVSP system supports video tracks encoded by AVC algorithm (AVC_SET_TYPE 121a atom) and HEVC (HEVC_SET_TYPE atom) 121b and audio tracks encoded by AAC algorithm (MP4A_SET_TYPE atom) 121d. However the resultant implementation can be further supplemented with other codecs. Each of the aforementioned atoms contains the atom substructures, defining the organization of network packets according to corresponding codec. This way AVC_NAL_ATOM_TYPE and HEVC_NAL_ATOM_TYPE contains the specific nal and nal_data info for network packages (representing Network Abstraction Layer), and MP4_ADTS_TYPE contains the array of adts data (Audio Data Transport Stream).

TS_CORRECTION_TYPE atom encapsulates timestamp data needed for frames synchronization in scope of the single audio or video track and for synchronization of different individual tracks with each other by metainformation PTS (Presentation Timestamp) and DTS (Decoding Timestamp). The connection between named atom and other ones is established by foreign key track_id (the unique identifier of each concrete media track).

One more content group within HOVSP data stream is defined by KEYS_TYPE 123 atom, encapsulating the collection of KEY_TYPE atoms, each of which holds a single cryptographic key needed for client-side content decryption.

The concrete media frames (audio and video content) are represented by Flexible atoms avc_idr_link 124 (AVC key frame), avc_ndr_link 125 (AVC non-key frame), hevc_idr_link 126 (HEVC key frame), hevc_ndr_link 127 (HEVC non-key frame) and aac_link 128 (AAC frame). Each from the aforementioned atoms contains mandatory atom header, time synchronization stream attributes tsinfo, pts_diff and dts_diff and the encrypted frame itself encrypted_data. To support the media frame decryption, each atom contains foreign key reference key_id to corresponding cryptographic key and initialization vector data iv_data.

The Reserved atoms LINK_TYPE provide many-to-many references between concrete media frames and tracks' metadata (for concrete codecs). For that purpose the track id (the foreign key to concrete TRACK_TYPE atom) and flexible (foreign key to concrete Flexible type, e.g. avc_idr_link, hevc_ndr_link etc.) attributes are used.

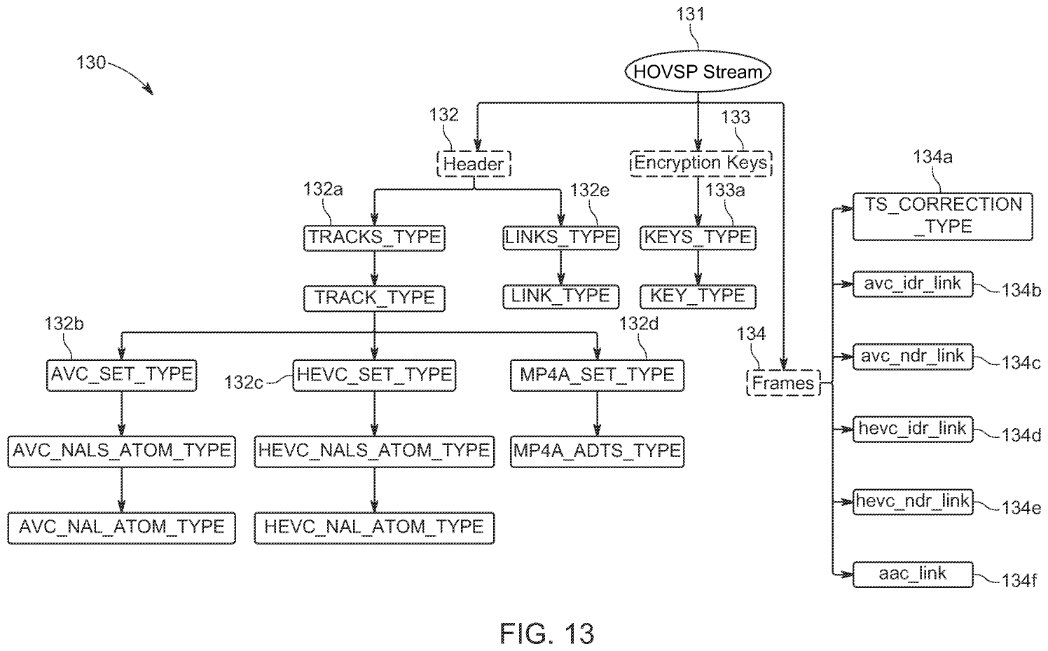

FIG. 13 demonstrates the HOVSP hierarchical structure in the form of a tree atom diagram. Herewith the blocks, having a dash border, represent the fictive structural organizational units, which are included in the diagram only for demonstrative purposes, but are not actually used in the process of HOVSP stream building and the further stream parsing on the client side. The Reserved Extended atoms are colored gray, the Flexible atoms (self-descriptive in the HOVSP stream header) are colored white on the diagram.

The root-level element of the hierarchy tree of the HOVSP Stream 131 is conceptually divided into three branches, each of which encapsulates the concrete data type, as per below:
Header 132—The block aggregating the header metadata for the entire HOVSP stream (besides which each individual atom has its own header with metadata, as described earlier):
   TRACKS_TYPE 132a—This Reserved Extended atom encapsulates the collection of metadata by all available HOVSP media tracks, encoded using a selected algorithm. The preferred system embodiment, according to the current patent, employs the codecs AVC/HEVC for video and AAC for audio (further system customization is available).
      TRACK_TYPE—Reserved Extended atom-wrapper for any concrete media track available in the scope of the HOVSP system
         AVC_SET_TYPE 132b/HEVC_SET_TYPE 132c/MP4A_SET_TYPE 133d—The concrete Reserved Extended atoms containing the track's metadata for corresponding media codec
         AVC NALS ATOM TYPE/HEVC NALS ATOM TYPE/MP4_ADTS_TYPE—Reserved Extended atoms containing the data of network packets for the arranged infrastructure according to corresponding media codecs (AVC, HEVC, AAC)
         AVC_NAL_ATOM_TYPE/HEVC_NAL_ATOM_TYPE—Reserved Extended atoms containing more concrete packet data of network infrastructure according to AVC and HEVC video codecs
   LINKS_TYPE 132e—This Reserved Extended atom encapsulates the links between concrete media frames and metadata of corresponding tracks.
      LINK_TYPE—Reserved Extended atom describing each individual link between concrete media frame atom and metadata of the corresponding track in the HOVSP structure
Encryption Keys 133—The block containing actual encryption keys and some supplemental metadata
   KEYS_TYPE 133a—Reserved Extended atom encapsulating the collection of cryptographic keys, needed for media content decryption on the client side
      KEY TYPE—Reserved Extended atom, holding in the HOVSP stream the data about the concrete cryptographic key
Frames 134—The block encapsulating the actual media frames (audio and video, encoded according to different applied algorithms)
   TS_CORRECTION_TYPE 134a—Reserved Extended atom, which does not encapsulate the actual media frame, but includes, according to its name, the timestamp correction data used both for the synchronization of individual frames with each other in the scope of the same media track and also for the synchronization of different tracks
   avc_idr_link 134a/avc_ndr_link 134b/avc_ndr_link 134c/hevc_idr_link 134d/hevc_ndr_link 134e/aac_link 134f—Flexible atom (self-descriptive in the stream header of atom LINK_TYPE), which directly encapsulates the data of the encrypted key/non-key frame encoded by AVC/HEVC/AAC algorithms, and also the cryptographic data for further frame decryption on client side (the unique key identifier and initialization vector for the symmetric crypto algorithm).

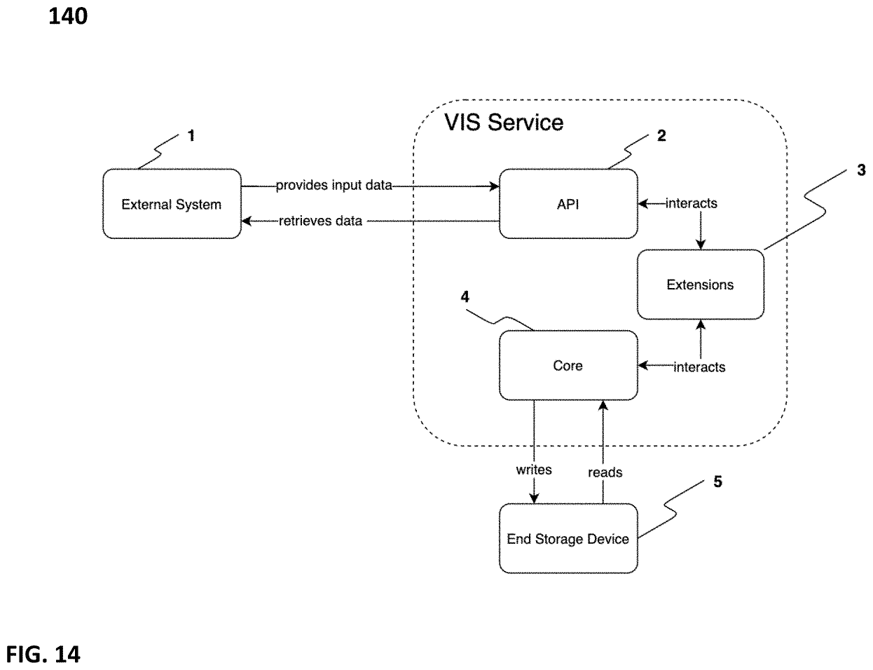

FIG. 14 demonstrates the block diagram depicting the high-level component structure of Verona Index Storage 140 (VIS). VIS is the software service that records the incoming data stream and/or reads previously recorded data from the hardware memory unit. Both processes are initiated by External System 1 and executed in parallel and independently, so the service can read and write data simultaneously. The Application Programming Interface (API) 2 is the only entry point for the external system(s). The API component sets the rules for intercommunication between the VIS service and the outside world and also documents the concrete types of available execution instructions. Additional expansion components Extensions 3 act as a bridge connecting the API and the main structural components Core 4, encapsulating fundamental service functions (data writing, reading and caching). It is important to note that the API 2 component never interacts with Core 4 directly, but Extensions 3 always serve as the intermediary link in such communications. End Storage Device 5 represents the destination memory storage subsystem (the combined hardware and software solution used for storing information).

The two fundamental operations of the VIS system are writing and reading.

In the case of data writing, API 2 catches the incoming data stream from the External System 1 and by means of ancillary components Extensions 3 transfers information to Core 4 components for further processing before the actual recording. After the data is arranged and prepared, it is finally recorded to the apparatus memory unit End Storage Device 5.

In the case of data reading, External System 1 sends the specific request to API 2. The API addresses the necessary instructions through ancillary components Extensions 3 to fundamental component Core 4 for the extraction of the requested data from the RAM cache subsystem (encapsulated by Core 4) involving ROM End Storage Device 5.

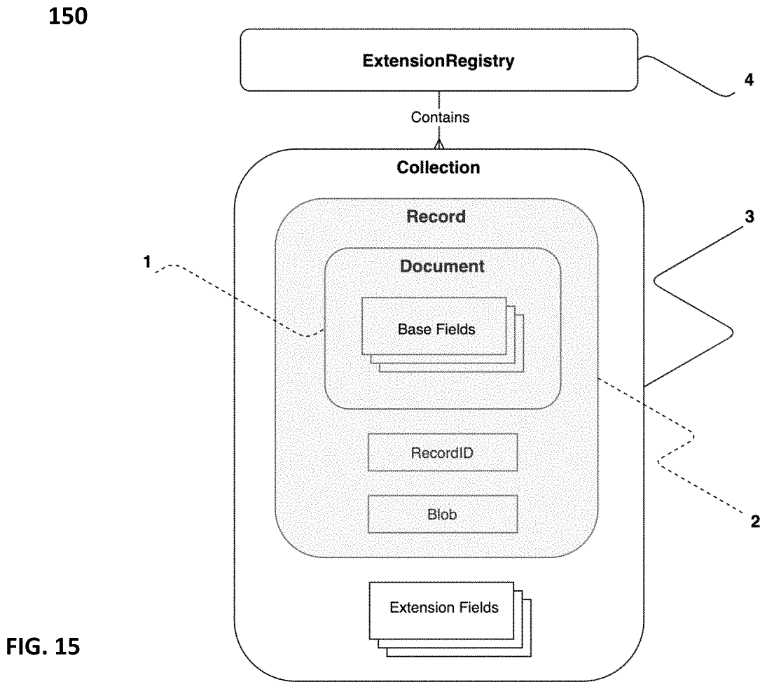

FIG. 15 depicts the structural organization of VIS entities 150. The core structure for any entity in the VIS system is represented by Document 1, which contains the unique identifier DocumentID and the set of mandatory properties for any possible object (Base Fields). Document represents the minimal unit of any stored metadata inside VIS and any element of the VIS system is either a Document itself or the entity expanding the basic Document structure with additional fields. Record 2 represents the Document extension, containing not only the Base Fields but also the reference to the actual data in the form of a single Blob block (Binary Large OBject). A Blob may have any arbitrary size (from 64 KB to 4 GB; always a multiple of 64 KB). Additionally, any Record contains the identifier RecordID, uniquely defining it as a complex of binary data (Blob) and metadata that describes it (Document). Both Document and Record structures (highlighted gray in the figure) are the basic predefined components of the VIS system, and their modification is not intended. However, the end software developers may introduce their own data types, ExtensionCollection 3, which are the specific access modes to concrete stored data and which extend the Record (and hence Document) structure by adding specific Extension Fields. Depending on their specific purpose, those additional fields may be of any arbitrary type and carry different meanings. For instance, the specific timestamp field may be added to hold time series data. All custom-added ExtensionCollection components are registered in ExtensionRegistry 4 and used independently to maintain access to different types of data held in permanent storage.

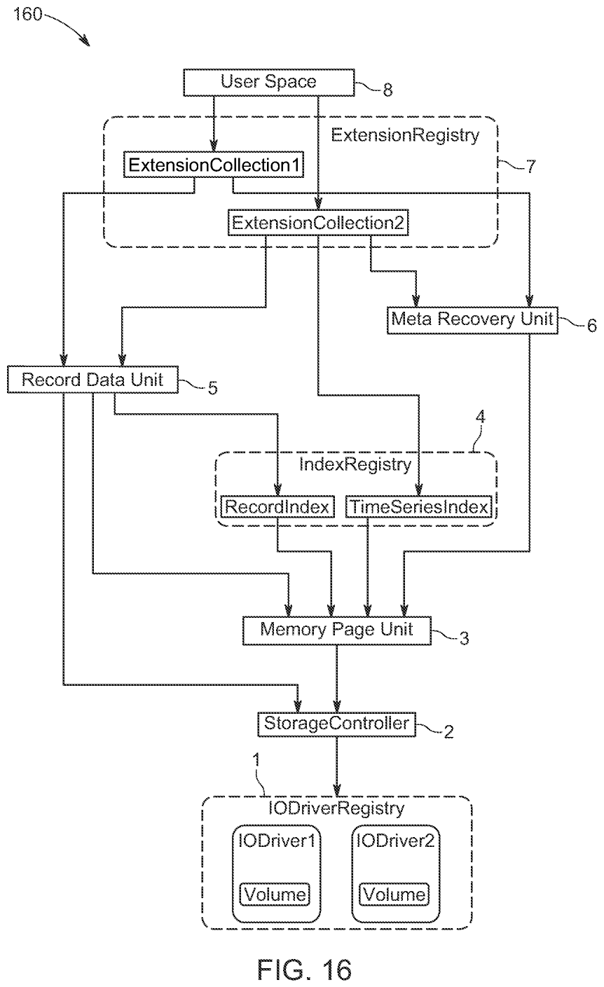

FIG. 16 shows the detailed structural scheme 160 of VIS. The scheme depicts components and their interconnections from top to bottom, i.e. from a higher abstraction layer to a lower one. The digital notation alternatively names components from bottom to top for better structural understanding. Components with a fixed structure (whose implementation is constant and not intended to be changed) are marked in gray. Components that can be changed or altered are marked in white.

The lowest level of the VIS system is represented by the component IODriverRegistry 1. This registry contains a concrete number of low-level input/output drivers IODriver (there are two of them shown, but the registry can be expanded by adding extra drivers). Each of these drivers is designed to work with the concrete end memory storage system (a combination of communication protocol, apparatus and software storage). By using different low-level drivers, the system can be adapted to virtually any combination of communication protocols (FTP, SMB, WebDAV, . . . ), hardware units (HDD, SSD, Flash, . . . ) and software storage systems (file, block or object). The input/output driver encapsulates the logical Volume (a marked up and formatted space block in the permanent memory). The Volume size is equal to 4 GB for most modern file systems (however this value can be changed if necessary). Different IODriver implementations can be combined (chained) to support complex data storage systems (with caching, mirroring, etc.) As a result, the data may be recorded to storage with a complex multilevel structure (e.g. network storage with local caching, RAID, etc.)

All input/output driver interconnections are controlled by the component StorageController 2, which acts as the only entry point for any low-level read/write operation involving the end storage apparatus. This component receives read/write instructions from higher-level components and manages data transfer in both directions (from/to storage unit) by means of different implementations of input/output drivers from IODriverRegistry 1.

Memory Page Unit (MPU) 3 represents the low-level subsystem that provides the instruments for working with a specific memory structure (Page), which contains a number of Document structures (described in detail in FIG. 15). The main operations of the MPU, available via the external interface, are Allocation (the process of reserving memory for the new document, which is written to permanent storage afterwards) and Translation (giving access to a previously saved document). The MPU also controls most intercommunications with the Cache Infrastructure (described in detail later).

IndexRegistry 4 contains different index implementations, meant to maintain random access to stored data and to effectively search for concrete information fragments. The preferred embodiment of the present invention contains two example indexes: RecordIndex and TimeSeriesIndex. RecordIndex gives access to Record objects (see FIG. 15 for details); the TimeSeriesIndex, as its name suggests, operates with time series data (i.e. information within a time interval). IndexRegistry can be extended by adding new specific index implementations for the concrete data types and technical use cases. Regarding the preferred embodiment, the implementation for both indexes is based on a modified balanced B+ tree data structure (described hereinbelow).

Record Data Unit (RDU) 5 has a higher abstraction level than MPU. RDU operates with the Record element, encapsulating Document (see details in FIG. 15 and its description). RDU leverages the corresponding RecordIndex to maintain effective searching and random access to Record elements.

Meta Recovery Unit (MRU) 6 is the element of the VIS system that's responsible for data structure control, fall-over protection and data recovery. For that purpose, the MRU uses the Checkpoint record-keeping system and the valid Write-Ahead Log (using the Copy-on-Write technique) for data recovery in case of software or hardware failure.

The ExtensionRegistry 7 component works with specific custom types of stored/processed data. This registry, as its name suggests, contains the extension of the base data structure Record in the form of specific custom components, ExtensionCollection. Each of these Collection elements describes the specific method of operation with stored/read data in ROM storage (see FIG. 15 for details about VIS entities relationships).

User Space 8 has the highest abstraction level in the VIS infrastructure. This component contains the documented interface for external interactions with VIS, so it is the only entry point to the system from the outside. User Space can directly interact only with specific components ExtensionCollection from ExtensionRegistry, which, in their turn, call other components.

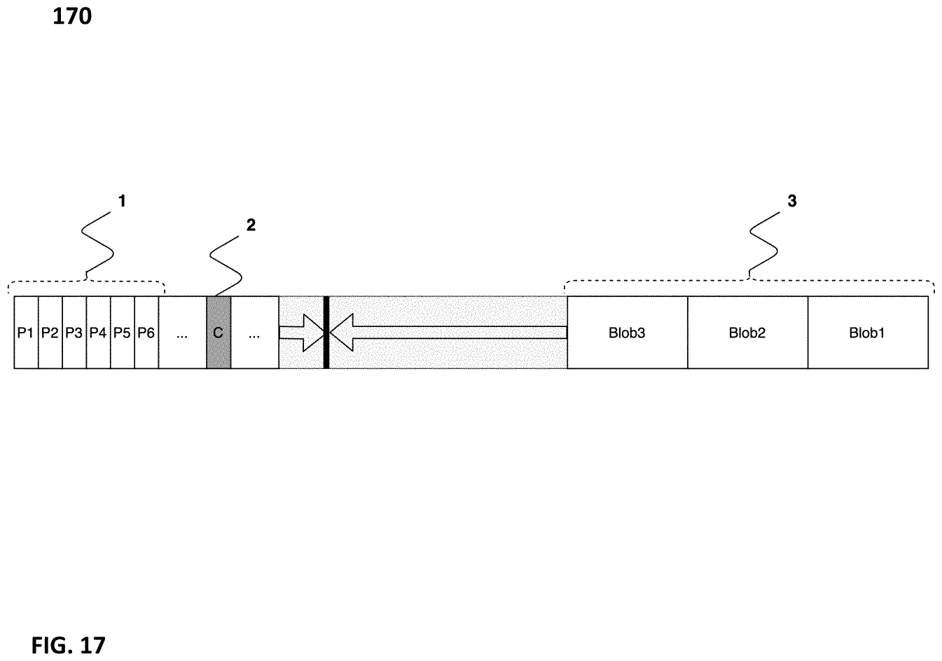

FIG. 17 represents the scheme of the permanent memory (ROM) arrangement 170 in the scope of VIS infrastructure. Permanent memory storage is conveniently classified into two areas. The left area 1 contains the Page structures, stacked up sequentially one by one (page identifiers are in ascending order). The Page structure has a fixed size determined by the specific constant value. For the preferred embodiment, the page size is 4 KB (however, like with most VIS parameters, the value of this parameter may also be changed). Each Page is divided into 128 logical memory cells of 32 bytes each. Consequently, one Document structure may occupy between one and all of the available cells within one Page (and have a size from 32 to 4096 bytes). Document size is always a multiple of 32 bytes. The concrete Documents stored in the permanent ROM are referred to as physical.

The specific elements that maintain storage fault tolerance are Checkpoint 2. The Checkpoint is actually the service Page, embedded each N pages, which, instead of metadata about real data, contains metadata about the structure of previous N−1 pages. According to the preferred embodiment of the current invention, N=32 (however, this value can be changed if necessary). Together with the Copy-on-Write resource-management technique (the data is not rewritten under the same physical address, but copied and changed in a new memory area), in the event of software or hardware failure, the Checkpoints allow the system to quickly localize corrupted data blocks (bypassing each 32nd page) and perform the rollback to a previous valid state, so that the VIS storage system contains the healthy Write-Ahead Log.

In addition to metadata (held in Pages) and service structures (held in Checkpoints), the ROM keeps the actual data. This may be video or audio fragments or data of any other arbitrary structure. This data is formed in Blob blocks contained in memory area 3. The block size is arbitrary, but it is always a multiple of 64 KB (this value can also be tuned according to concrete system needs) and cannot exceed the logical Volume size (4 GB). Data Blobs are also written sequentially, but from another storage end (from right to left in the figure).

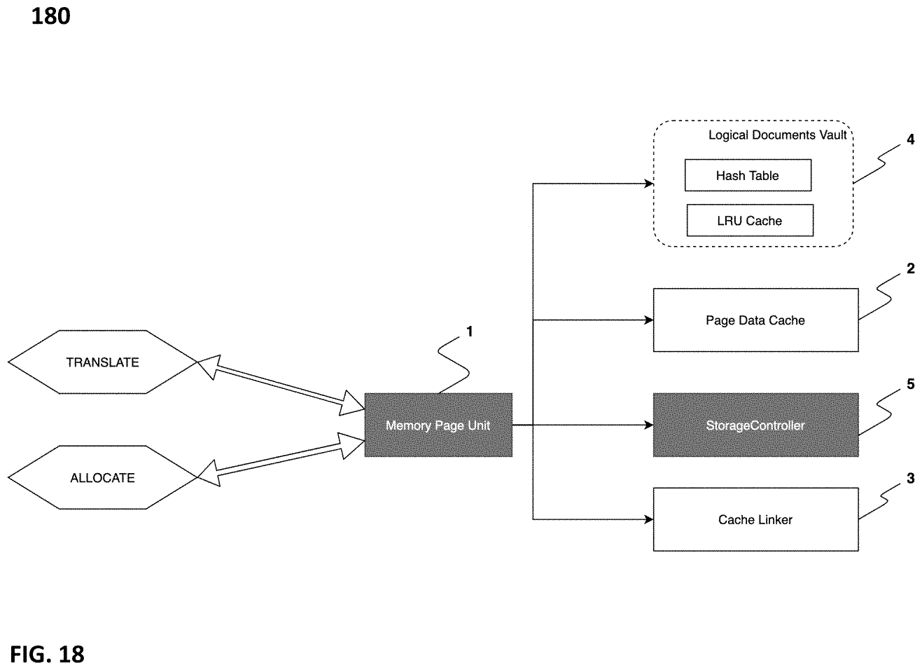

FIG. 18 represents the operational scheme of the cache 180 using Memory Page Unit. When MPU 1 is referred to by either of the instructions (Translate/Allocate), an interaction with the cache occurs. The cache is located in the operative memory (RAM) and it has a configurable size, which allows it to perform system operation fine-tuning (to strike a balance between performance and RAM space consumption). The Cache Infrastructure elements are Page Data Cache 2, Cache Linker 3 and Logical Documents Vault 4. Page Data Cache encapsulates the area of aligned memory, which is a multiple of the Page size (the preferred embodiment stipulates a size of 4 KB, but this parameter can be varied). The physical Pages are allocated here and it is from here that Pages are sent to the ROM, and also here that the Pages from the ROM are loaded. Thus, Page Data Cache in the RAM contains the logical copies of physical Pages from the ROM, together with the proper offsets applied. The maximum number of cached Pages is also defined by the specific parameter value. The element Cache Linker 3 encapsulates the linked list data structure, keeping cell numbers for Pages from Page Data Cache, and searches for available free Pages in cache. Logical Documents Vault 4 implements the logical cache structure and contains elements Hash Table and LRU Cache. Hash Table helps get the reference for the concrete Page by its PageID. Each time the Page is addressed via Hash Table, it is advanced in the Least Recently Used list (LRU). If the cache is filled to the threshold, the least recently used Page is discarded from the cache. StorageController 5 is used for the direct operation with physical Pages and Documents located in the ROM (reading and writing data). Once again, the elements highlighted gray (MPU 1 and StorageController 5) have a strictly fixed structure (their change is not intended by any scenario), while all other elements of Cache Infrastructure (Page Data Cache 2, Cache Linker 3 and Logical Documents Vault 5) can be varied or supplemented to fit specific technical needs.

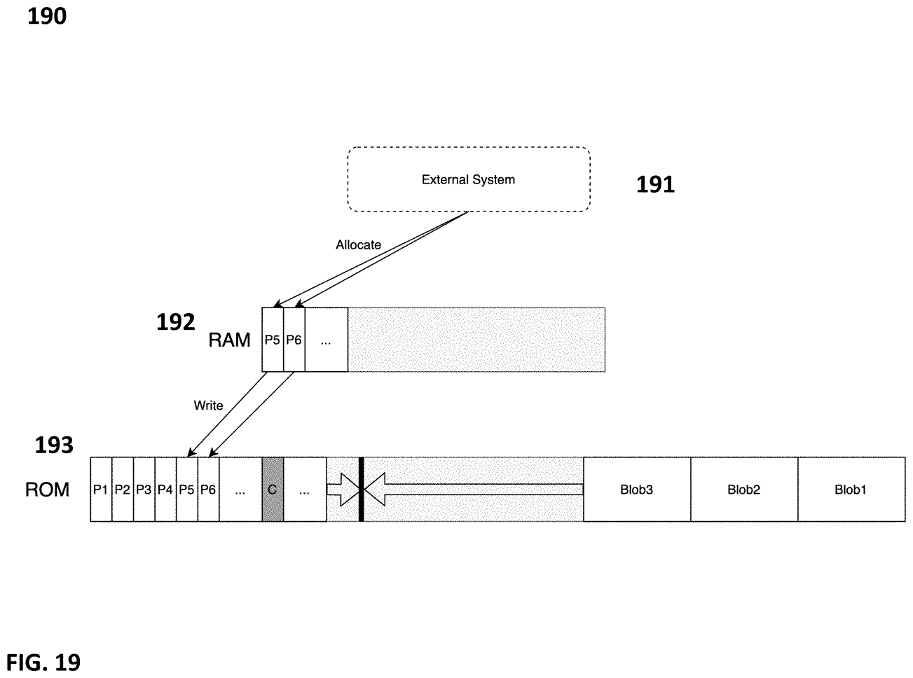

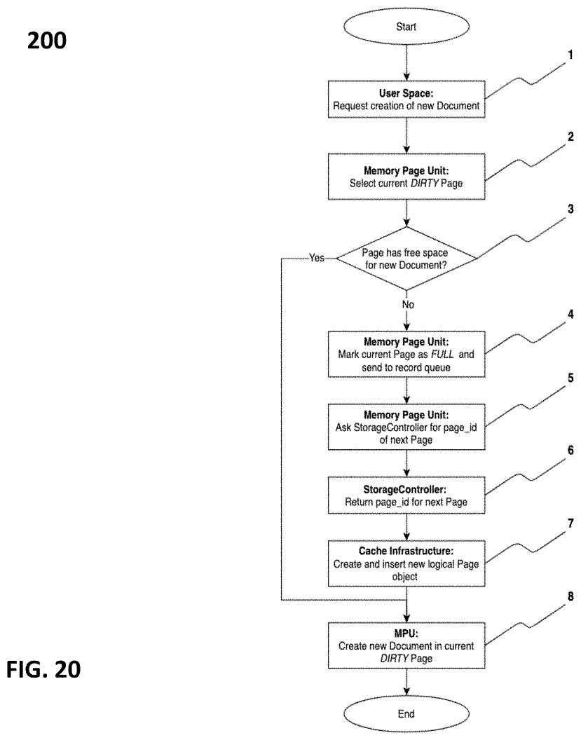

FIG. 19 represents the high-level scheme of the Allocation operation 190. Allocation is the operation of reserving memory for a new Document and/or Page in the RAM 192. The system can work with the freshly allocated Document right after the Allocation operation is completed (even before the actual Document structure is recorded to the ROM 193). The External System 191 initiates the creation of a new Document and uses the Allocate instruction to reserve the necessary space in RAM. The Document is either inserted into the current last Page (if there is space available) or a new Page is created in RAM and the Document is inserted there. VIS storage applies end-to-end numbering to Pages and Documents (throughout operative and permanent memory). ROM contains the Pages in ascending order of the index, while RAM may contain Pages in random order (as they may be accessed randomly). Finally, the Pages allocated in RAM are written into ROM sequentially one by one. The process is described in detail below in FIG. 20.

FIG. 20 demonstrates the Allocation flowchart 200—the process of memory reservation for the new Document. When new data is to be added to VIS, the external system calls the User Space 1 component and initiates new Document creation in the RAM. Memory Page Unit 2 selects the current DIRTY Page (the Page that is not completely filled with Documents and has not yet been sent to the recording queue in the ROM). If the selected Page contains enough free space for the new Document (check 3), then the procedure skips to step 8 and the Document is added to the selected Page; otherwise, the new Page needs to be created prior to the addition of the new Document. Let's consider this process in detail.

As the current last Page has no available space in which to save a new Document, the MPU finalizes it by marking it as FULL (step 4), showing that the page is filled completely and that no further Documents can be added to it. The Page is then sent to the ROM's recording queue (the process is further handled by the StorageController). The MPU then requests the PageID of the new page from the StorageController so that it can record the document into it (step 5). StorageController returns the requested PageID in step 6. Cache components (Logical Documents Vault, Page Data Cache, Cache Linker), united under the general term Cache Infrastructure, create the logical Page object and insert it into the RAM cache. When the MPU receives the Page to save the new Document, it calculates the offset for the document and inserts it (step 8).

The allocation process outlined above is repeated each time new data needs to be written.

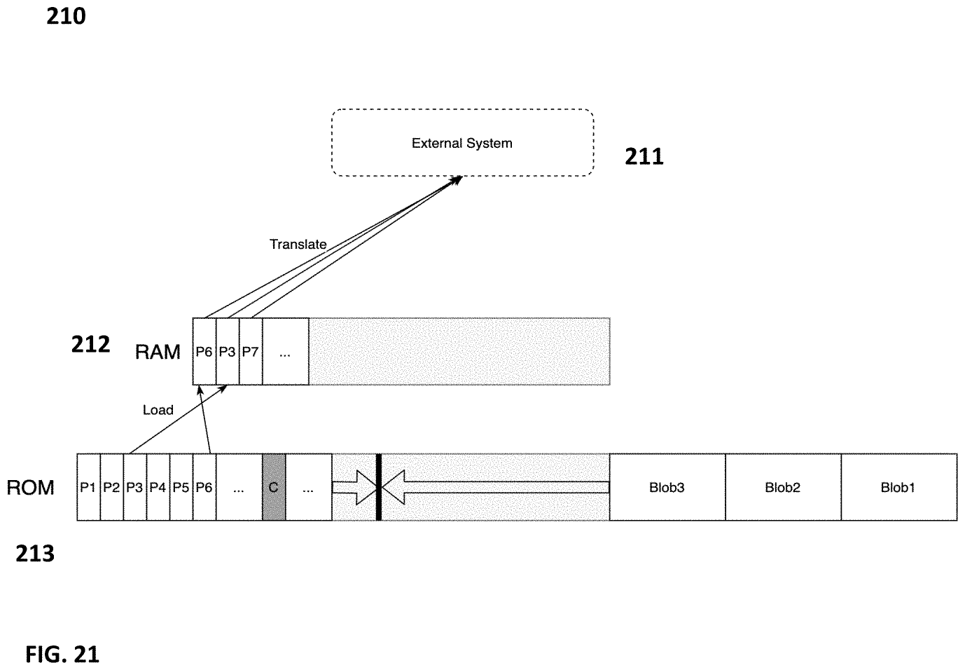

FIG. 21 represents the high-level scheme of the Translation operation. Translation is the operation of exposing previously recorded data from the VIS system by request from an External System 211. The External System requests the concrete data from the VIS by one or more DocumentIDs. The RAM 212 can either immediately return the required Page, containing the requested Document (if the data is already cached in the operative memory), or VIS will need to load the required Pages in the RAM cache and then return them by External System request (Pages can be loaded from ROM 213 to RAM in a random order). In any case, Cache Infrastructure is always involved in any read/write operation dealing with Pages and Documents.

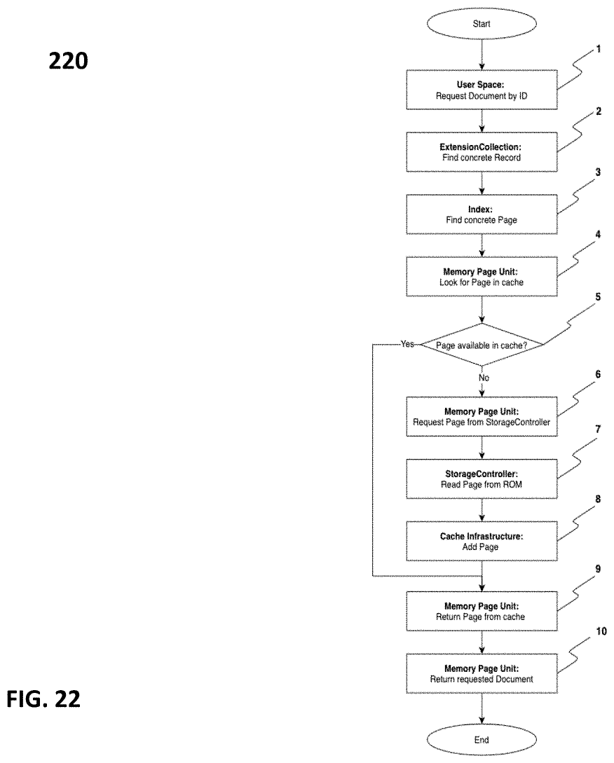

FIG. 22 demonstrates the Translation flowchart 220—the process of exposing previously recorded data by request from the External System. The Translation process can deliver data in three different cases:
The data (Document, Page) is already allocated in RAM, but not yet recorded to ROM (the live stream case).
The data is previously recorded to ROM, but not currently contained in the RAM cache.
The data is recorded to ROM and additionally duplicated in the RAM cache (the requested data has been accessed recently).

An important fact is that the RAM cache is involved in each of the three cases listed above, i.e. even if the data requested by the external system is currently not in the RAM cache, this data will be loaded there from the ROM before it is returned to the External System by request.

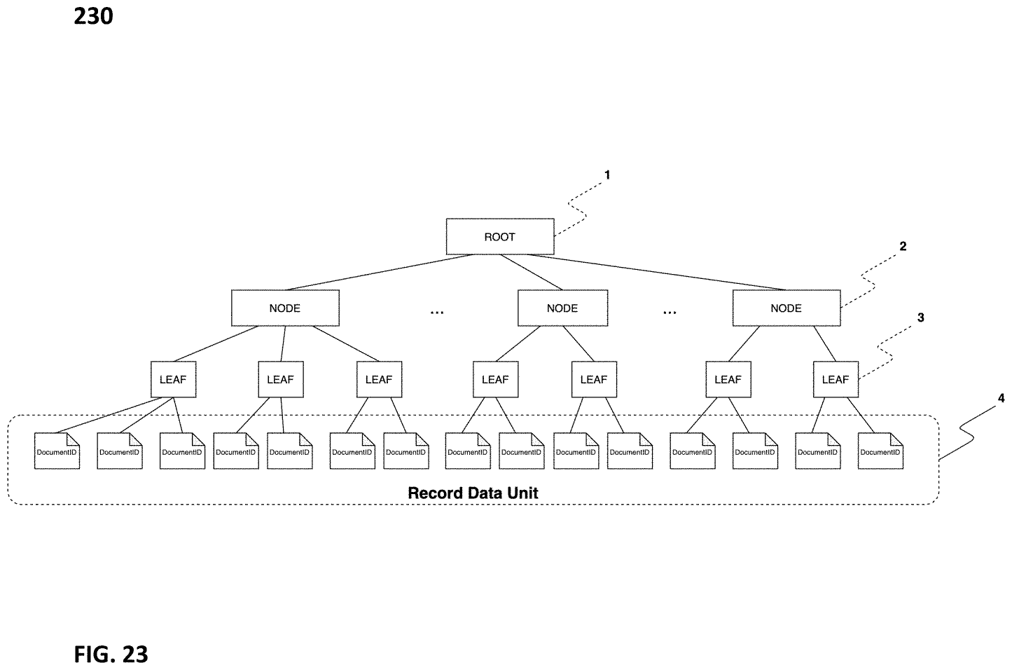

The Translation operation is the propagation of data, requested by the External System, from the RAM cache. If the requested data is currently not in the RAM cache, it will be loaded there prior to its return to the External System. In the preferred embodiment the information is requested from storage by one or more concrete DocumentID identifiers. The request is forwarded from the external world to User Space (step 1). User Space directs the request to the corresponding ExtensionCollection (step 2). Each of these custom collections encapsulates the strictly defined end data type stored in the ROM, and sets the method for operating with this data type. ExtensionCollection defines the specific Record object, which encapsulates the requested Document. The next step is to define what Page contains the concrete requested Document; that lookup is performed by the corresponding Index (step 3), mapped to a specific type of ExtensionCollection. According to the preferred embodiment of the VIS system, the custom balanced B+ tree structure is used as the foundation of different indexes (the implementation of which is depicted in FIG. 23). Any specific index component in the VIS infrastructure can be customized or replaced with another proprietary implementation if necessary.

After the concrete PageID is found in a specific Index, the MPU performs the data lookup in the cache (step 4). More specifically, Logical Documents Vault checks if the requested Page is available in Page Data Cache (step 5). If the page is already in the cache, it can simply be returned straight away (skip to step 9). Otherwise, the page containing the required document first needs to be read from ROM to RAM and returned by external request afterwards (this subprocess is described below).

If there is no requested Page in the cache, MPU requests the Page from StorageController (step 6) by PageID received from the index. After StorageController returns the requested Page (step 7), Cache Infrastructure components add it to the RAM cache (step 8). Now that the Page containing the requested Document is in the cache, it can be returned by external request (step 9) and the VIS can extract the requested Document applying the appropriate offset (step 10).

FIG. 23 depicts the structural scheme for the custom implementation of a balanced B+ tree structure 230. The given scheme shows the tree structure used in concrete RecordIndex implementation. B+ tree implementations for other indexes may vary from the outlined scheme (but the general principles are basically the same).

The B+ tree is the modification of a standard balanced binary tree structure. Like the regular binary tree, the B+ tree has the single root element ROOT 1. Internal nodes NODE 2 do not keep concrete data records, but only pointers to other internal nodes or leaves. The number of pointers to child nodes from any internal node (fanout) is relatively high (a few dozen or more).

The data values themselves are stored only in leaves (nodes without children) LEAF 3, and the number of leaves is also quite high (usually a few hundred). The values stored in leaves are the pointers to document identifiers DocumentID, which are used to get the concrete data chunks from VIS storage. Data retrieval process from ROM and RAM by concrete Documents is handled by RDU 4. The requested DocumentID is mapped to concrete RecordID, which keeps the actual data. Leaves are chained into a linked list structure, which enables data to be serially traversed (in addition to random access mode by tree pointers).

The B+ tree maintains a fixed height (i.e. all leaves have equal depth), which results in approximately equal access time to any data element. This is an essential aspect of any B+ tree structure implementation.

The significant drawback for most widely used implementations of the B+ tree is their resource consumption. Ideally, to perform effectively, the B+ tree needs to be fully deployed in the operative memory. The B+ tree implementation adopted for the preferred embodiment solves this issue by using the “lazy-loading” design pattern (each concrete period of time memory only contains the tree part that is currently in use).

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A digital media data management system and architecture comprising:
one or more media streaming and/or storage devices;
one or multiple end user devices;
a network communication device with internet connection;
a cloud authentication server; and
a reverse proxy server.

2. A digital media data management system and architecture of claim 1 further comprising:
multi IP data transfer potential between any end user devices and any media streaming and/or storage devices number through a LAN or via the internet, wherein said media streaming and/or storage devices are presented virtually as a Web server;
unification of data transfer methods for LAN and internet connection cases;
support of HTTP protocol;
support of Web socket protocol;
support of TCP protocol; and
support of SSL/TLS encryption.

3. The digital media data management system software architecture according to claim 1, further comprising the media server software system that in its turn follows the proprietary internal structure, constituting the key composite elements as follows:
an administrative component which processes the majority of control requests from clients and redirects those requests to proper components to be actually served;
an internal pipeline software component which conducts the data flow from the actual source to the recipient server components;
an intermediary linking component transmitting both requests from the client to a server in one direction and the data stream from the server to the client in the opposite direction employing the prepared network infrastructure;
the internal software-defined data storage service driving all the information read/write routines towards the non-transitory memory unit; and
the software adaptive bitrate streaming protocol and the technique setting the standards for the conversion, formatting, processing and network transfer of the data.

4. A software-defined data storage system according to claim 1 and a method for the effective recording, retrieving and storing of data, comprising:
circular memory arrangement by application of a loop recording technique;
a modifiable and extendable set of supported data types;
a component architecture organization which constituting both predefined and customizable/interchangeable subelements; and
a high level of overall system scalability and performance achieved by dedicated execution of parameter tweaks.

5. A software adaptive bitrate streaming protocol and the technique setting the standards for the organization, conversion, formatting, processing and network transfer of data combining the traits of both traditional real-time byte streaming protocols and modern adaptive bitrate HTTP-based techniques comprising the following:
a customizable, modifiable, codec-agnostic architecture independent of the concrete compression/decompression algorithms;
an existing network infrastructure with a minimal number of tweaks/changes which can be used for content transfer organization without requiring a content delivery network;
real-time video and audio latency with extremely low values of one to three seconds;
a stream quick start of between one and three seconds for video-on-demand;
an extremely low data stream redundancy for transferring complemented metainformation within the media stream itself;
a self-descriptive protocol structure allowing the easy and straightforward on-the-fly server content modification on the server side, and either automatic or manual seamless media track switching on the client side;
embedded fault tolerance and data integrity check techniques;
overall multiplexing/demultiplexing simplicity achieved by employing a proprietary container data format which significantly lowers the CPU load and requirements to RAM; and
assurance of encryption and security at the protocol level.

6. The software adaptive bitrate streaming protocol of claim 5 where the protocol may be applied as an element of the architecture or as an independent technique for any other system.

7. The digital media data management system and architecture of claim 1 further comprising a mechanism of mutual authentication and authorization of parties based on the application of PKI fundamentals to the client and server side, with both generating key pairs and sharing the public keys across the existing potentially unsafe network infrastructure under the control of a cloud server.

8. The digital media data management system and architecture of claim 1 further comprising a secure pairing routine applying PKI infrastructure to connections between client, server and cloud and also involving BLE and Wi-Fi hardware units in message transfer, and using the client's and server's protected software storage partitions to maintain sensitive private key data.

9. The digital media data management system and architecture of claim 1 further comprising:
secure data propagation and consumption, complemented by the key management organization technique for the system wherein the proprietary security architecture is based on PKI principles.

10. The technique complementing the streaming protocol according to claim 5, further comprising the effective data-buffering organization mechanism and providing a quick start to the streaming process and customizable latency of about one second, wherein the implemented buffering technique is based on the adaptive sizes of the buffer queue itself and the decoding and rendering queues, depending on network connection stability further allowing the client playback slowdown/speedup technique for stream normalization in case of network instability or failure.

11. The method of permanent memory arrangement for the storage system of claim 3, which implies hardware ROM unit formatting and classification into two separate memory areas as follows:
one that holds metadata structures providing convenient searching and access to concrete data fragments; and
the other that holds actual data blocks linked to aforementioned metadata objects, wherein the claimed memory organization also defines the specific service elements that ensure error tolerance and allow the system to perform effective data integrity checks.

12. A digital media data management system and architecture of claim 1 further comprising a software caching subsystem organization for the storage service including several software components entirely residing in the operative memory (RAM) and maintaining the effective mechanism for the allocation of memory to new data chunks, and the translation of previously recorded data by request of the external system(s).

13. A digital media data management system and architecture of claim 1 further comprising the specific data indexing mechanism which serves to improve the entire scope of read/write operations within the claimed system, wherein the indexing technique has high cohesion to system structural elements and infrastructure, which provides additional advantages in access rate and overall performance while it is used for data saving or retrieval in the claimed system.
